(19) United States
(12) Patent Application Publication
(10) Pub. No.: US 2024/0373878 A1
(43) Pub. Date: Nov. 14, 2024

(54) METHODS OF FEEDING POLYPHENOLS TO ANIMALS

(71) Applicant: NUTRITION SCIENCE DESIGN PTE. LTD, Bedok Gardens (SG)

(72) Inventors: David Kannar, Bedok Gardens (SG); Tracey Ann Hay, Bedok Gardens (SG); Grant Richards, Bedok Gardens (SG)

(73) Assignee: NUTRITION SCIENCE DESIGN PTE. LTD, Bedok Gardens (SG)

(21) Appl. No.: 18/574,560

(22) PCT Filed: Jun. 30, 2022
(86) PCT No.: PCT/SG2022/050458

§ 371 Date: Dec. 27, 2023

(30) Foreign Application Priority Data
Jun. 30, 2021 (SG) 1020107253T

(51) Int. Cl. A23K 20/111; A23K 10/33; A23K 10/38; A23K 50/90; C05F 5/00; C05F 17/05

(52) U.S. Cl. CPC A23K 20/111; A23K 10/33; A23K 10/38; A23K 50/90; C05F 5/008; C05F 17/05

(57) ABSTRACT

The present invention relates to methods of feeding polyphenols to animals, including associated feeds and preparation thereof, and methods of consuming animals fed the polyphenols.

### CROSS-REFERENCE

This application claims priority to Singaporean application SG 10202107253T (filed 30 Jun. 2021), the entire contents of which are incorporated herein by reference.

### FIELD OF THE INVENTION

The present invention relates to methods of feeding polyphenols to animals; feeds, drinks and premixes for feeding polyphenols to animals; and methods of preparing said feeds, drinks and premixes. The present invention further relates to insects and/or invertebrates fed polyphenols, methods of preparing the insects and/or invertebrates, foods comprising the insects and/or invertebrates, methods involving feeding the insects and/or invertebrates to animals.

### BACKGROUND OF THE INVENTION

There are growing concerns relating to the environmental impact of agriculture.

Minimisation of the waste generated during the cultivation and processing of sugar is desirable. Vinasse is a by-product of the fermentation of carbohydrates including sugar that is produced in large quantities. Fermentation of sugar can produce drinking alcohol including rum, cachaca, guaro and mekhong whiskey, which are produced by fermentation of sugar juice and/or molasses. Fermentation can also produce bioethanol or ascorbic acid. For each litre of alcohol produced in the sugarcane industry, 15 litres of vinasse can be generated. Vinasse is commonly about 93% water and about 7% solids (although this can vary and vinasse is often concentrated for use and/or sale). The vinasse remaining after distillation of the alcohol following fermentation of sugar is generally partially dehydrated until its viscosity is similar to that for molasses and then sold.

Vinasse is used as a fertilizer, in nutritive solutions for hydroponics, in the production of methane, in culture media for plant tissue culture and algae growth.

However, not all vinasse is repurposed and the disposal of vinasse poses serious environmental problems for soils and water bodies. Because of the large quantities of vinasse produced, developing further uses for vinasse is likely to assist the environment and minimise waste.

Vinasse produced from sugar cane is also called dunder. Dunder is rich in phytochemicals, including polyphenols. Polyphenols have been linked with health benefits, including benefits from antioxidant activity.

Recently anaerobic digestion has been investigated as a technology useful in repurposing certain waste streams. The process employs specialised bacteria to break down organic waste in an oxygen depleted environment to produce biogas, a liquid organic residue called digestate and a solid waste called sludge. Biogas is a mixture of methane, carbon dioxide, other gases, and water. Biogas can be combusted for heat and electricity or cleaned and compressed to be used as a vehicle fuel or as a substitute for natural gas. Digestate is a fibrous solid/sludge that can be used in the same way as compost for soil improvement.

There are also concerns regarding the environmental impact of animal raising and livestock production. A strategy to mitigate the environmental impacts of livestock production is the provision of high quality feedstock, thus facilitating rapid raising. Insects and invertebrates have been used in the past as a high quality feedstock for livestock production.

Insects and invertebrates are also a high protein food source. Relative to many other high protein food sources, insects and invertebrates can be intensively raised with little impact upon the environment. Reasons for this include because relative to many other high protein food sources; in general insects and invertebrates possess high fecundity rates and a short life cycle that involves rapid growth. Most insects and invertebrates are also well adapted to intensive production due to their ease of husbandry and harvest, and relatively low environmental footprint.

The use of insects and invertebrates as a food for humans is also growing.

There is a need for further strategies to reduce agricultural waste. There is also a need for improved quality feedstocks for animal raising, particularly livestock production. Similarly, there is also a need for improved high protein food sources for human consumption. It would be particularly desirable if such an improved high quality feedstock or human food could be rapidly generated using widely available and economical inputs.

Reference to any prior art in the specification is not an acknowledgment or suggestion that this prior art forms part of the common general knowledge in any jurisdiction or that this prior art could reasonably be expected to be understood, regarded as relevant, and/or combined with other pieces of prior art by a skilled person in the art.

### SUMMARY OF THE INVENTION

### Feeds

In one aspect, the invention provides an animal feed comprising 1-80 mg GAE/g or 1-8,000 mg GAE/100 g.

In another aspect, the present invention provides an animal feed comprising:
a polyphenol composition;
a nutrient component;
optionally a micronutrient component
optionally a non-nutrient component;
wherein the feed comprises 1-8,000 mg GAE/100 g polyphenols.

In a further aspect, the present invention provides an animal feed comprising:
a polyphenol composition;
a nutrient component;
optionally a micronutrient component
optionally a non-nutrient component;
wherein the polyphenol composition comprises 500 to 15,000 mg GAE/100 g polyphenols. Optionally, the feed comprises 1-8,000 mg GAE/100 g polyphenols.

Optionally, the feed comprises 100-8,000 mg GAE/100 g, 10-5,000 mg GAE/100 g, 50-3,000 mg GAE/100 g, 100-5,000 mg GAE/100 g, 100-3,000 mg GAE/100 g, 500-8,000 mg GAE/100 g, 1,000-8,000 mg GAE/100 g, 500-5,000 mg GAE/100 g, or 500-3,000 mg GAE/100 g. Optionally, the polyphenol composition is 0.5-50%, 1-50%, 1-30%, 10-30%, 1-20%, 1-10%, or 0.5-10% of the feed by weight. Optionally, the polyphenol composition comprises 500 to 15,000 mg GAE/100 g polyphenols. Optionally, the nutrient component is 40-99.5% of the feed by weight. The micronutrient and non-nutrient components are optionally each independently 0-20% of the feed by weight.

Optionally, polyphenol composition is at least 0.25%, 0.5%, 0.75%, 1%, 2%, 3%, 4%, 5%, 7.5%, 10%, 15%, 20%, 25%, 30%, 40%, 50%, or 60% by weight of the feed fed to the animal.

Optionally, polyphenol composition is less than or equal to 60%, 50%, 40%, 30%, 25%, 20%, 15%, 10%, 7.5%, 5%, 4%, 3%, 2%, 1%, 0.75%, 0.5% or 0.25% of the feed fed to the animal.

It will be appreciated that the feed may comprise any value listed above concerning the percentage of the feed the polyphenol composition in the feed between at least 0.25% and less than or equal to 60%; for example between at least 4% and less than or equal to 20%.

In some embodiments, the nutrient component further comprises one or more of plant matter, animal matter and fungal matter. Plant matter is preferred. Fungal matter is also preferred. In some embodiments, the polyphenol composition further comprises one or more of leaf matter, grain matter, vegetable matter, fruit matter, meat, offal, mushroom matter and yeast. Leaf matter, grain matter, vegetable matter, fruit matter, mushroom matter and yeast are preferred. Agricultural waste streams are preferred, particularly vegetable or fruit production waste streams, more preferably fruit production waste streams such as pomace, more preferably apple pomace and/or grape pomace. Leaf matter is also particularly preferred. Fungal matter such as yeast is preferred, with Brewer's yeast particularly preferred. In some embodiments, the polyphenol composition further comprises one or more of sugar, carbohydrate, lipid (ie fat) and protein. The carbohydrate is preferably in the form of fibre. The sugar may be in the form of a composition such as molasses. Sugar and carbohydrate are preferred.

In some embodiments, the animal feed, such as the nutrient component or non-nutrient component of the animal feed, further comprises a waste stream from animal production or management of a different animal. For instance, a finfish feed may comprise a waste stream from chicken production or management. Waste streams from animal production include streams from animal raising such as streams comprising dung and/or partially eaten feed. Waste streams from animal management include waste streams from animal slaughter, such as one or more of offal, bone (preferably ground), blood and feathers. Waste streams from poultry (especially chicken production) and pig production are preferred. The inclusion of waste streams from animal production or management is preferred when the animal is a maggot. Waste streams from poultry (especially chicken production) and pig production are preferred.

Optionally, the polyphenol composition is an antioxidant. Optionally, the polyphenol composition increases the shelf-life of the feed.

All components of the feed are edible for the species being fed the feed. Specifically the polyphenols must be in an edible format.

### Feed Premixes

In another aspect, the present invention provides an animal feed premix comprising:
a polyphenol composition;
optionally a micronutrient component
optionally a non-nutrient component;
wherein premix is for combination with at least a nutrient component to prepare a feed comprising 1-8,000 mg GAE/100 g polyphenols, preferably 100-5,000 mg GAE/100 g. Optionally, the polyphenol composition comprises 500 to 15,000 mg GAE/100 g polyphenols. Preferably, the premix is the sole source of polyphenols for the feed. Optionally, the premix includes instruction to include an amount of premix into a feed that will result in a feed comprising 1-8,000 mg GAE/100 g polyphenols, preferably 100-5,000 mg GAE/100 g. Optionally, the premix comprises 100-5,000 mg GAE/100 g, 500-5,000 mg GAE/100 g or 1,000-5,000 mg GAE/100 g.

Optionally, the polyphenol composition is an antioxidant. Optionally, the polyphenol composition increases the shelf-life of the feed premix and/or the feed premix increases the shelf-life of the feed.

All components of the feed premix are edible for the species being fed the feed made from the premix. Specifically the polyphenols must be in an edible format.

### Options for Feeds and Feed Premixes

The polyphenol composition is preferably about 7,000 to 12,000 mg GAE/100 g, more preferably 8,000 to 11,000 mg GAE/100 g. In some embodiments, the polyphenol composition is 100-5,000 mg GAE/100 g. Optionally, the polyphenol composition is about 10,000 mg GAE/100 g. The polyphenol composition is optionally as described in PCT/SG2020/050777 or as described elsewhere in the specification.

The polyphenol composition is optionally 10-15% ash. The polyphenol composition is optionally ≤5 Pol % w/w, preferably ≤3 Pol % w/w, ≤1 Pol % w/w. The polyphenol composition is optionally sugar free. The polyphenol composition is optionally 20-25 μS/cm conductivity.

Optionally, the polyphenols in the polyphenol composition are sugar cane polyphenols. Optionally, the polyphenol composition comprises, consists essentially of or consists of a sugar cane vinasse and/or sugar cane digestate, preferably a sugar cane digestate, more preferably a digestate of sugar cane vinasse. The polyphenol composition optionally comprises sugar cane vinasse and/or sugar cane digestate formed during preparation of bioethanol, rum, amino/organic acid, yeast propagation or a combination thereof. The sugar cane vinasse of the polyphenol composition is optionally prepared from sugarcane juice, massecuite and combinations thereof. The sugar cane digestate of the polyphenol composition is optionally an anaerobic digestate. The sugar cane digestate of the polyphenol composition optionally includes more than 7000 mg GAE/100 g polyphenols. The polyphenol composition is optionally a filtrate or dried filtrate, preferably an affinity filtration filtrate such as an activated carbon filtrate and/or an ion-exchange resin filtrate.

In some embodiments, the polyphenol composition has (i) no odour; (ii) does not contribute odour to the feed or premix; (iii) has less odour than the usual odour of sugar cane vinasse and/or digestate. (iv) the polyphenol composition has an odour intensity of 0-3 (preferably 1-3) according to the VDI 3882-1 olfactometry standard; or (v) combinations or one or more of (i) to (iv).

In some embodiments, the polyphenol composition is not an extract.

The sugar cane vinasse and/or sugar cane digestate are optionally as described in PCT/SG2020/050777 or as described elsewhere in the specification.

The polyphenol composition is optionally liquid or powdered.

Optionally, the feed is a non-human animal feed. Preferably, the feed is an insect and/or invertebrate feed.

The feed is optionally a solid, semi-solid, a meal, powdered, a suspension, or a liquid (ie a beverage).

The feed premix is optionally a solid, semi-solid, a meal, powdered, a suspension, or a liquid.

The feed premix is optionally suitable for formulation into a feed that is a solid, semi-solid, a meal, powdered, a suspension, or a liquid.

Where the feed or premix is a beverage respective weights of ingredients are dry weights.

The feed or feed premix may comprise a sweetener. Sweeteners are preferred when the polyphenol content of the feed or the feed that the premix is suitable to be formulated into is high.

Optionally, the non-nutrient component comprises one or more of fibre, a pharmaceutical agent, a pigment (such as xanthophyll), a growth factor, an anti-microbial agent and an enzyme (such as phytase). Fibre is preferred.

Optionally, the polyphenol composition comprises one or more minerals. Preferably the polyphenol composition comprises one or more of potassium, calcium, magnesium, phosphate, nitrate, sulphate, and sodium. Optionally, the polyphenol composition comprises:
one or more of:
(a) 0.02-410 mg/g calcium;
(b) 0.001-27 mg/g phosphorus;
(c) 0.02-300 mg/g magnesium;
(d) 0.1-1500 mg/g potassium;
(e) 0.003-47 mg/g sodium; and
(f) 0.008-134 mg/g sulphur.

Optionally, the polyphenol composition includes more than 0.027 mg/g, 2.7 mg/g, 27 mg/g, 81 mg/g, 135 mg/g, 216 mg/g, 270 mg/g or 405 mg/g calcium. Optionally, the polyphenol composition includes less than 405 mg/g, 270 mg/g, 216 mg/g, 135 mg/g, 81 mg/g, 27 mg/g, 2.7 mg/g, or 0.027 mg/g calcium.

Optionally, the polyphenol composition includes more than 0.0018 mg/g, 0.18 mg/g, 1.8 mg/g, 5.4 mg/g, 9 mg/g, 14.4 mg/g, 18 mg/g or 27 mg/g phosphorus. Optionally, the polyphenol composition includes less than 27 mg/g, 18 mg/g, 14.4 mg/g, 9 mg/g, 5.4 mg/g, 1.8 mg/g, 0.18 mg/g or 0.0018 mg/g phosphorus. Phosphorus may be in the form of phosphate.

Optionally, the polyphenol composition includes more than 0.02 mg/g, 2 mg/g, 20 mg/g, 60 mg/g, 100 mg/g, 160 mg/g, 200 mg/g or 300 mg/g magnesium. Optionally, the polyphenol composition includes less than 300 mg/g, 200 mg/g, 160 mg/g, 100 mg/g, 60 mg/g, 20 mg/g, 2 mg/g or 0.02 mg/g magnesium.

Optionally, the polyphenol composition includes more than 0.1 mg/g, 10 mg/g, 100 mg/g, 300 mg/g, 500 mg/g, 800 mg/g, 1000 mg/g or 1500 mg/g potassium.

Optionally, the polyphenol composition includes less than 1500 mg/g, 1000 mg/g, 800 mg/g, 500 mg/g, 300 mg/g, 100 mg/g, 10 mg/g or 0.1 mg/g potassium.

Optionally, the polyphenol composition includes more than 0.0031 mg/g, 0.31 mg/g, 3.1 mg/g, 9.3 mg/g, 15.5 mg/g, 24.8 mg/g, 31 mg/g or 46.5 mg/g sodium. Optionally, the polyphenol composition includes less than 46.5 mg/g, 31 mg/g, 24.8 mg/g, 15.5 mg/g, 9.3 mg/g, 3.1 mg/g, 0.31 mg/g or 0.0031 mg/g sodium.

Optionally, the polyphenol composition includes more than 0.0089 mg/g, 0.89 mg/g, 8.9 mg/g, 26.7 mg/g, 44.5 mg/g, 71.2 mg/g, 89 mg/g or 133.5 mg/g sulphur. Optionally, the polyphenol composition includes less than 133.5 mg/g, 89 mg/g, 71.2 mg/g, 44.5 mg/g, 26.7 mg/g, 8.9 mg/g, 0.89 mg/g or 0.0089 mg/g sulphur. Sulphur may be in the form of sulphate.

It will be appreciated that the polyphenol composition may comprise any value listed above concerning the concentration of an element between the values for that element provided.

Optionally, the polyphenol composition includes protein. The protein may comprise more than 1%, 3%, 5%, 10%, 15%, 20%, 25% or 35% of the polyphenol composition (w/w). The protein may comprise less than 35%, 25%, 20%, 15%, 10%, 5%, 3% or 1% of the polyphenol composition (w/w). It will be appreciated that the polyphenol composition may comprise any value listed above between the values for the percentages of protein provided.

### Processes for Preparing Feeds and Premixes

In another aspect, the invention provides a process for making an animal feed, the process comprising:
combining a polyphenol composition with at least a nutrient component, thereby generating an animal feed.

Optionally, optionally the method further comprises combining of a micronutrient component and/or a non-nutrient component with the polyphenol composition, nutrient component or both.

Optionally, the method further includes dehydrating the animal feed.

Optionally, the method further includes adding liquid to the animal feed. In some embodiments, adding liquid reconstitutes the animal feed. In some embodiments, adding liquid results in an animal feed that is a beverage and/or suspension.

The animal feed, polyphenol composition, nutrient component, micronutrient component and non-nutrient component are optionally as described in PCT/SG2020/050777 or as described elsewhere in the specification.

In another aspect, the invention provides a process for making an animal feed premix, the process comprising:
combining a polyphenol composition with a further premix component, thereby generating an animal premix.

Optionally, the further premix component is one or more of a micronutrient component or a non-nutrient component.

Optionally, the method further includes dehydrating the animal feed premix.

Optionally, the method further includes adding liquid to the animal feed premix. In some embodiments, adding liquid reconstitutes the animal feed premix. In some embodiments, adding liquid results in an animal feed premix that is a liquid or suspension.

The animal feed premix, polyphenol composition, nutrient component, micronutrient component and non-nutrient component are optionally as described in PCT/SG2020/050777 or as described elsewhere in the specification.

### Methods of Feeding Polyphenols to Animals

In another aspect, the invention provides a method of feeding one or more animal comprising providing a polyphenol composition to the one or more animal, wherein the polyphenol composition comprises 500 to 15,000 mg GAE/100 g polyphenols.

The polyphenol composition is optionally as described in PCT/SG2020/050777 or as described elsewhere in the specification. The animal is optionally fed a feed as described elsewhere in the specification. The animal is optionally fed a feed prepared from a feed premix described elsewhere in the specification.

The method optionally comprises feeding the polyphenol composition to the animal daily. Alternately, polyphenol composition is fed to the animal every second or third day or 3-6 times per week. Optionally, the polyphenol composition is fed to the animal for a period of at least 2 days, 3 days, 4 days, 5 days, 6 days, week, 2 weeks, 3 weeks, 4 weeks, 5 weeks, 6 weeks, 7 weeks, 8 weeks, 9 weeks, 10 weeks, 3 months, 4 months, 5 months, or 6 months.

Optionally, the polyphenol composition is fed to the animal for a period of less than or equal to the previous 6 months, 5 months, 4 months, 3 months, 10 weeks, 9 weeks, 8 weeks, 7 weeks, 6 weeks, 5 weeks, 4 weeks, 3 weeks, 2 weeks, week, 6 days, 5 days, 4 days, 3 days, or 2 days.

It will be appreciated that the animal may be fed the polyphenol composition for any period listed above between at least 2 days and less than or equal to the 6 months; for example between at least the previous week and less than or equal to the previous 8 weeks.

Optionally, the animal is fed the polyphenol composition during a developmental phase involving rapid growth. Alternatively, the animal is fed the polyphenol composition during a non-rapid growth or weight maintenance phase. Alternatively, the animal is fed the polyphenol composition as part of a diet that increases one or more of lean muscle mass, protein mass and/or decreases fat mass. In some embodiments, feeding the animal the polyphenol composition as part of a diet increases lean muscle mass. In some embodiments, feeding the animal the polyphenol composition as part of a diet increases protein mass. In some embodiments, feeding the animal the polyphenol composition as part of a diet decreases fat content. Preferably, feeding the animal the polyphenol composition as part of a diet increases lean muscle mass by 0.25% or more, 0.5% or more, 0.75% or more, 1% or more, 2% or more, 4% or more, 6% or more, 8% or more, 10% or more, 12% or more, 15% or more, or 20% or more. Preferably, feeding the animal the polyphenol composition as part of a diet increases protein mass by 0.25% or more, 0.5% or more, 0.75% or more, 1% or more, 2% or more, 4% or more, 6% or more, 8% or more, 10% or more, 12% or more, 15% or more, or 20% or more. Preferably, feeding the animal the polyphenol composition as part of a diet decreases fat mass by 0.25% or more, 0.5% or more, 0.75% or more, 1% or more, 2% or more, 4% or more, 6% or more, 8% or more, 10% or more, 12% or more, 15% or more, or 20% or more. Preferably, feeding the animal the polyphenol composition as part of a diet increases protein mass and decreases fat mass. Optionally, an increase in protein mass and a decrease fat mass is by any of the percentages specified above with respect to protein mass and/or fat mass. Alternatively, the animal is fed the polyphenol composition as part of a diet that increases the percentage in dry matter of one or more of lean muscle mass, protein mass and decreases fat mass. In some embodiments, feeding the animal the polyphenol composition as part of a diet increases the percentage in dry matter of lean muscle mass. In some embodiments, feeding the animal the polyphenol composition as part of a diet increases the percentage in dry matter of protein mass. In some embodiments, feeding the animal the polyphenol composition as part of a diet decreases the percentage in dry matter of fat content.

Preferably, feeding the animal the polyphenol composition as part of a diet increases the percentage of lean muscle mass in dry matter by 0.25% or more, 0.5% or more, 0.75% or more, 1% or more, 2% or more, 4% or more, 6% or more, 8% or more, 10% or more, 12% or more, 15% or more, or 20% or more. Preferably, feeding the animal the polyphenol composition as part of a diet increases the percentage of protein mass in dry matter by 0.25% or more, 0.5% or more, 0.75% or more, 1% or more, 2% or more, 4% or more, 6% or more, 8% or more, 10% or more, 12% or more, 15% or more, or 20% or more. Preferably, feeding the animal the polyphenol composition as part of a diet decreases the percentage of fat mass in dry matter by 0.25% or more, 0.5% or more, 0.75% or more, 1% or more, 2% or more, 4% or more, 6% or more, 8% or more, 10% or more, 12% or more, 15% or more, or 20% or more. Preferably, feeding the animal the polyphenol composition as part of a diet increases the percentage of protein mass and decreases the percentage of fat mass in dry matter. Optionally, an increase in the percentage of protein mass and a decrease in the percentage of fat mass in dry matter is by any of the percentages specified above with respect to protein mass percentage and/or fat mass percentage. The anti-inflammatory effects of the polyphenols are expected to assist with animal health.

In some embodiments, feeding the animal the polyphenol composition as part of a diet decreases the feed conversion ratio of the animal. Optionally, the feed conversion ratio of the animal is decreased by at least 1%, 2%, 3%, 4%, 5%, 7.5%, 10%, 12.5%, 15%, 17.5%, 20%, 25%, or 30%.

In some embodiments, feeding the animal the polyphenol composition as part of a diet increases the feed conversion ratio of the animal. Optionally, the feed conversion ratio of the animal is increased by at least 1%, 2%, 3%, 4%, 5%, 7.5%, 10%, 12.5%, 15%, 17.5%, 20%, 25%, or 30%.

In some embodiments, feeding the animal the polyphenol composition as part of a diet increases one or more of the growth rate, and weight of the animal. Optionally, one or more of the growth rate, and weight of the animal is increased by at least 1%, 2%, 3%, 4%, 5%, 7.5%, 10%, 12.5%, 15%, 17.5%, 20%, 25%, or 30%. In some embodiments, the method modulates the oxidative response of the animal.

In some embodiments, the method has an antiparasitic effect in and/or on the animal. In some embodiments, the method treats or prevents parasites in and/or on the animal.

In some embodiments, the method treats and/or prevents parasitic protozoa and/or parasitic helminths.

In some embodiments, the method treats and/or prevents parasites in terrestrial animals (preferably dogs, cattle, goats, pigs, or poultry, more preferably poultry, most preferably chickens) and/or aquatic animals (preferably finfish, including freshwater and saltwater finfish).

In some embodiments, the method treats and/or prevents coccidiosis in an animal in need thereof. Preferably, the animal is one or more of a dog, cattle, goat, or poultry. More preferably, the animal is poultry, even more preferably in turkey or chickens, most preferably in chickens. Coccidiosis is caused by coccidian protozoa.

In some embodiments, the method treats and/or prevents scuticociliatosis in an animal in need thereof. Preferably, the animal is finfish, more preferably salt water fish, most preferably in turbot. Scuticociliatosis is caused by the histiophagous scuticociliate Philasterides dicentrarchi.

In some embodiments, the method treats and/or prevents helminth in an animal in need thereof, preferably Hysterothylacium sp or Ascaris suum. Preferably, the animal is pigs or finfish, preferably in freshwater finfish. Preferably, the method is for the treatment or prevention of Hysterothylacium sp in finfish, particularly in freshwater finfish. Preferably, the method is for the treatment or prevention of Ascaris suum in pigs.

In some embodiments, the method reduces the oxidative stress in an animal in need thereof.

Methods where the Animal is an Invertebrate or Insect

Optionally, the animal is one or more insect or invertebrate and the method increases one or more of the growth rate and weight of the insect and/or invertebrate. Optionally, the animal is one or more insect or invertebrate and the method decreases the feed conversion ratio of the insect and/or invertebrate. Optionally, the nutritional value of the one or more insect or invertebrate is improved by the method. Nutritional value may be improved by a change in one or more of vitamin content, mineral content, energy content, lipid (ie fat) content, carbohydrate content, protein content and antioxidant content. Such increases, decreases and improvements are relative to the same insect and/or invertebrate fed an equivalent diet lacking the polyphenol composition.

Optionally, one or more of the growth rate, and weight of the one or more insect or invertebrate is increased by at least 1%, 2%, 3%, 4%, 5%, 7.5%, 10%, 12.5%, 15%, 17.5%, 20%, 25%, or 30%.

Optionally, the feed conversion ratio of the one or more insect or invertebrate is decreased by at least 1%, 2%, 3%, 4%, 5%, 7.5%, 10%, 12.5%, 15%, 17.5%, 20%, 25%, or 30%.

Optionally, the protein content of the one or more insect or invertebrate is increased by at least 1%, 2%, 3%, 4%, 5%, 7.5%, 10%, 12.5%, 15%, 17.5%, 20%, 25%, or 30%.

Optionally, the lipid content of the one or more insect or invertebrate is decreased by at least 1%, 2%, 3%, 4%, 5%, 7.5%, 10%, 12.5%, 15%, 17.5%, 20%, 25%, or 30%. Optionally, the fat content of the one or more insect or invertebrate is decreased by at least 1%, 2%, 3%, 4%, 5%, 7.5%, 10%, 12.5%, 15%, 17.5%, 20%, 25%, or 30%.

Preferably, feeding the insect or invertebrate the polyphenol composition as part of a diet increases protein content and decreases fat and/or lipid content. Optionally, an increase in protein content and a decrease fat and/or lipid content is by any of the percentages specified above with respect to any one of protein content, fat content, and lipid content.

Alternatively, feeding the insect or invertebrate the polyphenol composition as part of a diet increases the percentage in dry matter of protein content and/or decreases fat content. In some embodiments, feeding the insect or invertebrate the polyphenol composition as part of a diet increases the percentage in dry matter of protein content. In some embodiments, feeding the insect or invertebrate the polyphenol composition as part of a diet decreases the percentage in dry matter of fat content.

Preferably, feeding the insect or invertebrate the polyphenol composition as part of a diet increases the percentage of protein mass in dry matter by 0.25% or more, 0.5% or more, 0.75% or more, 1% or more, 2% or more, 4% or more, 6% or more, 8% or more, 10% or more, 12% or more, 15% or more, or 20% or more. Preferably, feeding the insect or invertebrate the polyphenol composition as part of a diet decreases the percentage of fat mass in dry matter by 0.25% or more, 0.5% or more, 0.75% or more, 1% or more, 2% or more, 4% or more, 6% or more, 8% or more, 10% or more, 12% or more, 15% or more, or 20% or more. Preferably, feeding the insect or invertebrate the polyphenol composition as part of a diet increases the percentage of protein mass and decreases the percentage of fat mass in dry matter. Optionally, an increase in the percentage of protein mass and a decrease in the percentage of fat mass in dry matter is by any of the percentages specified above with respect to protein mass percentage and/or fat mass percentage.

### Foods Comprising Insects or Invertebrates

In one aspect, the invention provides an animal feedstock or human food comprising an insect or invertebrate prepared by feeding the insect or invertebrate polyphenols in accordance with the methods of feeding polyphenols to animals described in this disclosure.

In one aspect, the invention provides an animal feedstock or human food comprising an insect and/or an invertebrate, wherein the insect and/or the invertebrate has been fed a polyphenol composition, feed or feed prepared from a feed premix described in this disclosure.

In some embodiments, the insect and/or invertebrate is live. In some embodiments, the insect and/or invertebrate is whole. In some embodiments, the insect and/or invertebrate is dried. In some embodiments, the insect and/or invertebrate is divided. In some embodiments, the insect and/or invertebrate is ground. In some embodiments, the insect and/or invertebrate is powdered. In some embodiments, the insect and/or invertebrate is dissolved. In some embodiments, the insect and/or invertebrate is liquid. In some embodiments, the insect and/or invertebrate is a suspension. In some embodiments, the insect and/or invertebrate is an extract (preferably, an oil-based extract).

In some embodiments, the animal feedstock or human food is solid. Examples of solid feeds includes pellets and granules.

In some embodiments, the animal feedstock or human food is a meal (ie ground material).

In some embodiments, the animal feedstock or human food consists of or consists essentially of one or more insect or invertebrate.

In some embodiments, the animal feedstock or human food further comprises one or more of plant matter, animal matter and fungal matter. Plant matter is preferred. Fungal matter is also preferred. In some embodiments, the animal feedstock or human food further comprises one or more of leaf matter, grain matter, vegetable matter, fruit matter, meat, offal, mushroom matter and yeast. Leaf matter, grain matter, vegetable matter, fruit matter, mushroom matter and yeast are preferred. Agricultural waste streams are preferred, particularly vegetable and/or fruit production waste streams, preferably fruit production waste streams such as pomace, preferably apple pomace and/or grape pomace. Leaf matter is also particularly preferred. Fungal matter such as yeast is preferred, with Brewer's yeast particularly preferred. In some embodiments, the animal feedstock or human food further comprises one or more of sugar, carbohydrate, lipid (ie fat) and protein. The carbohydrate is preferably in the form of fibre. The sugar is preferably in the form of a composition such as molasses. Sugar, carbohydrate and lipid (ie fat) are preferred for animal feedstocks. Carbohydrate and lipid (ie fat) are preferred for human food.

In some embodiments, the animal feedstock further comprises a waste stream from animal production or management of a different animal. For instance, a finfish feedstock may comprise a waste stream from chicken production or management. Waste streams from production include streams from raising such as streams comprising dung and/or partially eaten feedstock. Waste streams from management include waste streams from slaughter, such as one or more of offal, bone (preferably ground), blood and feathers. Waste streams from poultry (especially chicken production) and pig production are preferred.

In some embodiments, the animal feedstock or human food is animal feedstock. In some embodiments, the animal feedstock or human food is human food. In some embodiments, the insect is human food. In some embodiments, the invertebrate is human food.

### Processes of Preparing Animal Feedstock or Human Food

In one aspect, the invention provides a process for preparing an animal feedstock or human food comprising
feeding an insect or invertebrate polyphenols optionally in a polyphenol composition;
harvesting the insect or invertebrate;
optionally combining the insect or invertebrate with an additional edible component
to prepare an animal feedstock or human food.

The animal feedstock, human food, polyphenol composition, nutrient component, micronutrient component and non-nutrient component are optionally as described in PCT/SG2020/050777 or as described elsewhere in the specification.

Methods of Feeding Insects and/or Invertebrates to Animals

In a one aspect, the invention provides a method of feeding an insect and/or an invertebrate to an animal, the method comprising:
selecting one or more insect or invertebrate that has been fed a polyphenol composition; and
feeding the one or more insect or invertebrate to an animal.

Optionally, the one or more insect or invertebrate has been fed a polyphenol composition or feed or feed prepared from a feed premix as described in this specification. Optionally, the one or more insect or invertebrate has been fed polyphenols in accordance with a method described in this specification.

In some embodiments, the method improves the feed conversion ratio of the animal. Depending upon the context, an improvement may result in a decrease or increase in feed conversion ratio. For instance, a decrease in feed conversion ratio may be an improvement if an increase in the efficiency of weight gain is desired. This is often the case for animals propagated in agriculture or aquaculture. In other contexts, an increase in feed conversion ratio may be an improvement if a loss or control of weight in the animal is desired. This is often the case for humans and companion animals. An increase in feed conversion ratio can also result in an increase in lean muscle mass that is accompanied by a loss in fat mass. In such a context, feed conversion ratio may increase with respect to overall animal mass but decrease with respect to lean muscle mass. This can be highly desirable in high quality animals propagated in agriculture and aquaculture. Such increases, decreases and improvements are relative to the same animal fed an equivalent diet lacking the insect or invertebrate that has been fed a polyphenol composition.

In some embodiments, the animal feedstock or human food improves or maintains the gastrointestinal health of the animal or human. Preferably, the gastrointestinal health of the animal or human is improved. In some embodiments, animal feedstock or human food improves the microbiome. An improvement of the microbiome includes an increase in diversity of species and/or total number of gut bacteria.

Optionally, the method comprises feeding daily. Alternately, the method comprises feeding every second or third day or 3-6 times per week. Optionally, the one or more insects or invertebrates is fed to the animal for a period of at least 2 days, 3 days, 4 days, 5 days, 6 days, 1 week, 2 weeks, 3 weeks, 4 weeks, 5 weeks, 6 weeks, 7 weeks, 8 weeks, 9 weeks, 10 weeks, 3 months, 4 months, 5 months, or 6 months. Multiple feeds per day are considered daily feeding.

In some embodiments, the insect and/or the invertebrate fed to the animal comprises at least 0.25%, 0.5%, 0.75%, 1%, 2%, 3%, 4%, 5%, 7.5%, 10%, 15%, 20%, 25%, 30%, 40%, 50%, 60% or 80% of the total feed of the animal.

In some embodiments, the insect and/or the invertebrate fed to the animal comprises less than or equal to 80%, 60%, 50%, 40%, 30%, 25%, 20%, 15%, 10%, 7.5%, 5%, 4%, 3%, 2%, 1%, 0.75%, 0.5% or 0.25% of the total feed of the animal.

It will be appreciated that the insect and/or the invertebrate that has been fed to the animal may comprise any value listed above concerning the total feed of the animal during the defined period between at least 0.25% and less than or equal to 80%; for example between at least 4% and less than or equal to 20%.

### Agricultural Feeds or Fertilisers

Insects and invertebrates fed a high polyphenols diet, produce frass with increased polyphenol content and/or castings with increased polyphenol content.

In another aspect, the invention provides a method of preparing an agricultural feed or fertiliser comprising:
Collecting one or more frass or casting of one or more insect or invertebrate fed polyphenols (such as a polyphenol composition as described elsewhere in the specification or an animal feed or animal feed premix as described elsewhere in the specification); and
Preparing an agricultural feed or fertiliser comprising the one or more frass or casting.

In another aspect, the invention provides a method comprising:
Feeding one or more insect or invertebrate polyphenols (such as a polyphenol composition as described elsewhere in the specification or an animal feed or animal feed premix as described elsewhere in the specification);
Collecting one or more of the frass or castings of the one or more insect or invertebrate;
Using the one or more of the frass or castings to prepare an agricultural feed or fertiliser.

In the above methods, optionally frass of one or more insect is used to prepare an agricultural feed or fertiliser (preferably an agricultural feed). In the above methods, optionally castings of one or more invertebrate is used to prepare a fertiliser.

In the above methods, optionally the one or more insect or invertebrate is fed a polyphenol composition in accordance with the methods of feeding polyphenols to animals described in the specification.

Optionally, the insect or invertebrate producing the frass is fed a feed that is 30% or more, 40% or more, or 50% or more polyphenol composition. Optionally, the insect or invertebrate producing the frass is fed a feed that is 1,000-5,000, or 3,000-5,000 mg GAE/100 g polyphenols. Optionally, the insect or invertebrate producing the frass is fed the polyphenols for at least 2 months, at least 60 days or at least 70 days. Optionally, each insect or invertebrate is fed about 1 g (or 1 g or more) polyphenol composition over the at least 2 months, at least 60 days or at least 70 days. Optionally, the insect or invertebrate is fed 5-20, 10-20, 12-16, 13-15, or about 14 mg polyphenol composition per day. Optionally, the insect or invertebrate is fed 1-4, 2-4, 2.4-3.2, 2.6-3, or about 2.8 μg of GAE polyphenols per day.

Further aspects of the present invention and further embodiments of the aspects described in the preceding paragraphs will become apparent from the following description, given by way of example and with reference to the accompanying drawings.

### BRIEF DESCRIPTION OF THE DRAWINGS

FIG. 1 depicts the mean growth of each group of mealworms over time, as described in Example 1.

FIG. 2 depicts the total growth of each group of mealworms, as described in Example 1. Total group weight gain is depicted in the bars. Mean worm weight gain of each group is depicted by the line.

### DETAILED DESCRIPTION OF THE EMBODIMENTS

Reference will now be made in detail to certain embodiments of the invention. While the invention will be described in conjunction with the embodiments, it will be understood that the intention is not to limit the invention to those embodiments. On the contrary, the invention is intended to cover all alternatives, modifications, and equivalents, which may be included within the scope of the present invention as defined by the statements.

Further aspects of the present invention and further embodiments of the aspects described in the preceding paragraphs will become apparent from the following description, given by way of example.

All of the patents and publications referred to herein are incorporated by reference in their entirety.

For purposes of interpreting this specification, terms used in the singular will also include the plural and vice versa.

One skilled in the art will recognize many methods and materials similar or equivalent to those described herein, which could be used in the practice of the present invention. The present invention is in no way limited to the methods and materials described.

It will be understood that various terms employed in the specification, examples and statements have meanings that will be understood by one of ordinary skill in the art. However, certain terms are defined below.

As used herein, except where the context requires otherwise, the term “comprise” and variations of the term, such as “comprising”, “comprises” and “comprised”, are not intended to exclude further additives, components, integers or steps.

It must be noted that as used herein and in the appended statements, the singular forms “a”, “an” and “the” include plural reference unless the context clearly dictates otherwise.

The term “and/or” can mean “and” or “or”.

The term “(s)” following a noun contemplates the singular or plural form, or both.

Various features of the invention are described with reference to a certain value, or range of values. These values are intended to relate to the results of the various appropriate measurement techniques, and therefore should be interpreted as including a margin of error inherent in any particular measurement technique. Some of the values referred to herein are denoted by the term “about” to at least in part account for this variability. The term “about”, when used to describe a value, may mean an amount within ±25%, ±10%, ±5%, ±1% or ±0.1% of that value.

Embodiments discussed with respect to the feeding of the insect and/or invertebrate in the passive voice also apply in the active voice as embodiments of methods featuring an active feeding step and vice versa. The term “meat” includes flesh from both terrestrial animals and aquatic animals.

The term “affination syrup” refers to a syrup used at a sugar refinery in the preparation of affined sugar. Raw sugar and water are combined, slowly agitated and heated (eg up to 45° C.) to soften the raw sugar syrup layer. This is then centrifuged. Syrup passes through the centrifuge screens and the sugar crystals (affined sugar) remain behind. The crystals are washed with water and that water often combined with the syrup to form affination syrup, which is heated (eg to about 76° C.) before combination with a new batch of raw sugar.

The term “anaerobic” refers to something living, active, occurring, or existing in the absence of free oxygen. For example, an anaerobic digestate is a digestate prepare in anaerobic conditions by anaerobic microorganisms.

The term “bagasse” refers to sugar fibre either from sugar cane or sugar beet. It is the fibrous pulp left over after sugar juice is extracted. Bagasse products are commercially available, for example, Phytocel is a sugar cane bagasse product sold by KFSU.

The term “Biochemical Oxygen Demand” (BOD) is a measure of the amount of food (or organic carbons) that bacteria can oxidize. BOD (biochemical oxygen demand) indicates the amount of biodegradable matter in effluent.

The term “chemical oxygen demand” (COD) is an indicative measure of the amount of oxygen that can be consumed by reactions in a measured solution. It is the total measurement of all chemicals in the water that can be oxidized but provides no information on their biodegradability.

The term “daily” with respect to feeding includes multiple feeds per day.

The terms “efficacious” or “effective amount” refer to an amount that is biologically or chemically effective. In this context, one example is an effective amount of polyphenols in a sugar product to achieve a low glycaemic sugar.

The term “extract” refers to a composition extracted or removed from something else. For example, an extract can be prepared by solubilising a soluble fraction from an original product into an extraction solvent. An extract can also be prepared by precipitating an insoluble fraction from an original product out of an extraction solvent.

The extract is a product of combining the original product (for instance, plant based material) and extraction solvent (for instance, ethanol). The fraction of the original product is solubilised into the extraction solvent to form a supernatant, the supernatant is separated from the remnants of the original product, and removed with the extraction solvent. The extract is the supernatant including the solubilised portion in the extraction solvent, or a concentrate or dried version thereof. The remnants of the original product, such as plant matter, left behind and/or precipitated following extraction is not an extract.

As used herein, the term “fat” includes both fats and oils, unless the context requires otherwise.

The term “beet juice” refers to the liquid exiting a diffuser after the beet roots have been sliced into thin strips called cossetes and passed into a diffuser to extract the sugar content into a water solution. This liquid remains beet juice through various processing until solidified by crystallisation. Preferably, the beet juice is a deodorized beet juice.

The term “cane juice” or “sugar cane juice” refers to the syrup produced from pressed and/or crushed peeled sugar cane. Ideally sugar cane juice is at least 60° Brix.

The term “feed conversion ratio” refers to the mass of the input feed divided by the mass of the output product. Suitable output products will depend upon the animal being fed. For instance, the output product may refer to meat or another output such as eggs or milk. The output product may be lean muscle mass. An output of lean muscle mass is preferred in animals propagated in agriculture or aquaculture, preferably poultry or finfish, more preferably chickens. The output product may be protein. The output product may be oil. The output product may be chitin. An output of one or more of protein, oil and chitin is preferred when the animal is an insect, preferably a mealworm.

The term “filtrate” refers to a composition that has been filtered, for example, by size or affinity filtration.

The term “food grade” refers to products suitable for human or animal consumption or both, including products suitable for combination with other products to prepare a food.

The terms “improve”, “increase” or “decrease” refer to their common meaning and are measured in compared to a control. For example, an increase in growth rate based on consumption of the polyphenol composition is measured by comparison with the growth rate when an animal is fed equivalent feed without the polyphenol composition.

The term “massecuite” refers to a dense suspension of sugar crystals in the mother liquor of sugar syrup. This is the suspension that remains after concentration of the sugar juice into a syrup by evaporation, crystallisation of the sugar and removal of molasses. The massecuite is the product that is washed in a centrifuge to prepare bulk sugar crystals.

The terms “Micronutrient component” refers to a dietary component that provides one or more necessary cofactors for metabolism to occur. These components are generally minerals, vitamins, and amino acids.

The terms “Non-nutrient component” refers to a component that is not a nutrient component or a micronutrient component that may be added to a diet. Examples of non-nutrient components include fibre, pharmaceutical agents, pigment (such as xanthophyll), growth factors, anti-microbial agents and enzymes (such as phytase). Despite not being a nutrient component or a micronutrient component, the inclusion of non-nutrient components in a diet can offer many benefits. For instance, they may assist treating and/or controlling disease, in improving growth performance and improving the efficiency of feed utilisation.

The terms “Nutrient component” refers to a dietary component that is one of the components that provides the bulk of energy and protein for metabolism. These components are generally proteins, carbohydrates, fats and oils.

The term “odourless” refers to no discernible odour. In particular, odour is not discerned by a human in close proximity (eg 10 cm away).

The term “phytochemical” refers generally to biologically active compounds that occur naturally in plants.

The term “polyphenol” refers to chemical compounds that have more than one phenol group. There are many naturally occurring polyphenols and many are phytochemicals. Flavonoids are a class of polyphenols. Polyphenols including flavonoids naturally occur in sugar cane. In the context of the present invention the polyphenols that naturally occur in sugar cane are most relevant. Polyphenols in food are micronutrients that are of interest because of the role they are currently thought to have in prevention of degenerative diseases such as cancer, cardiovascular disease or diabetes.

The terms “Preventing” or “prevention” means preventing the occurrence of the disease or infection or symptoms thereof. For example, preventing parasitic infections or tempering or controlling the severity of the parasitic infections developed subsequent to the administration of the compositions comprising polyphenols of the present invention.

The term “reduced” refers to an amount lower than a reference amount. Reduced odour can be an odour lower than the previous odour of a specific sample of vinasse and/or digestate. Alternatively, the reduced odour can be lower than the usual odour for the vinasse and/or digestate. A polyphenol composition (ie vinasse or digestate of the invention) has a reduced odour when there is no odour following combining the polyphenol composition with white refined sucrose or raw mill sugar to produce a 10, 15, 20, 30, 40 or 50 mg GAE polyphenol/100 g carbohydrate sugar/polyphenol blend.

The term “sugar cane digestate” refers to digestate containing sugar cane polyphenols. The digestate can be prepared from a feed stock ultimately sourced from sugar cane such as sugar cane juice, sugar cane molasses, massecuite, raw or brown sugar cane, or sugar cane vinasse. Sugar cane vinasse is preferred.

The term “sugar cane vinasse” refers to vinasse containing sugar cane polyphenols. The vinasse can be prepared from a feed stock ultimately sourced from sugar cane such as sugar cane juice, sugar cane molasses, massecuite, or raw or brown sugar cane sugar. Sugar cane juice or molasses are preferred.

The term “sugar juice” refers to the syrup or liquid produced from sugar-rich plant feedstocks, such as the juice produced following crushing/pressing sugar cane or the liquid exiting a diffuser during the processing of sugar beets.

The terms “treating” or “treatment” are used herein to refer to curative therapy, prophylactic therapy and preventative therapy. Thus, by way of example, in the context of the present disclosure the term “treating” encompasses curing, ameliorating, or tempering the severity of parasites infections and/or associated diseases or their symptoms.

### Suitable Animals

Animals suitable to be fed the polyphenol composition, feed premix or feed of the invention include humans and non-human animals. In some embodiments, a human is to be fed the polyphenol composition, feed premix or feed of the invention. In some embodiments, a non-human animal is to be fed the polyphenol composition, feed premix or feed of the invention. Preferred non-human animals include insects, invertebrates, amphibians (particularly frogs), reptiles (particularly lizards and tortoises), birds (particularly companion birds, pigeons, and poultry, preferably poultry such as chickens, ducks, geese, turkeys and quails), finfishes (particularly carp, tilapia, catla, salmon, roho labeo, milkfish, tuna, trout, catfish, barramundi, turbot and eel), shellfishes (particularly crabs, crayfishes, lobsters, prawns and shrimps), monogastric animals (particularly pigs), ruminants (particularly cattle, sheep, goat and deer) and pseudo-ruminants (particularly horses, camels and rabbits). Birds and finfish are particularly preferred. In some embodiments, the animal is a bird. Poultry is preferred. Chickens are particularly preferred. In some embodiments, the chicken is a broiler. In some embodiments the chicken is a layer. Ducks are particularly preferred. Turkeys are particularly preferred. In some embodiments, the animal is a finfish. Tuna are particularly preferred. Salmon are particularly preferred. Trout are particularly preferred. In some embodiments, the animal is a pig. Animals propagated in agriculture, animals propagated in aquaculture and companion animals are preferred. In some embodiments, the animal is propagated in agriculture. In some embodiments, the animal is propagated in aquaculture. In some embodiments, the animal is a companion animal (particularly a dog, cat, fish, ferret, pig, rodent, lizard, tortoise, rabbit or bird). Dogs, cats, lizards and fish are preferred companion animals, with dogs and cats particularly preferred. In some embodiments, the animal is livestock. In some embodiments, the animal is an insect or invertebrate. In some embodiments, the animal is an insect. Preferred insects and invertebrates include a beetle, grasshopper, locust, butterfly, moth, fly, cricket, cicada, dragonfly and annelid. In some embodiments, the animal is an insect. Larval stages are preferred when the animal is an insect, for instance, grubs, maggots, mudeyes, caterpillars and mealworms. Mealworms are particularly preferred. Mealworms are the larval form of darkling beetles. There are numerous species of darkling beetles, preferred species include Zophobas morio, Tenebrio molitor, Tribolium castaneum, Alphitobius diaperinus and Ulomoides dermestoides. Zophobas morio, Tenebrio molitor and Alphitobius diaperinus are particularly preferred. In some embodiments, the mealworm is Zophobas morio larva. In some embodiments, the mealworm is Tenebrio molitor larva. In some embodiments, the mealworm is Alphitobius diaperinus larva. Maggots are particularly preferred. Maggots are the larval form of flies. There are numerous species of flies, preferred species include Hermetia illucens and Musca domestica. Grasshoppers, crickets (preferably Acheta domesticus), locusts (preferably Locusta migratoria), cicadas, mealworms, caterpillars (preferably Bombyx mori) and grubs are preferred. In some embodiments, the animal is an invertebrate. In some embodiments, the invertebrate is an annelid. Earthworms and marine worms such as beach worms are preferred. In some embodiments, the animal is an earthworm. In some embodiments, the animal is a marine worm.

Insects and invertebrates suitable to be fed a polyphenol composition, feed premix or feed of the invention to make a suitable food for an animal include a beetle, grasshopper, locust, butterfly, moth, fly, cricket, cicada, dragonfly and annelid. In some embodiments, an insect is suitable to be fed a polyphenol composition, feed premix or feed of the invention to make a suitable food for an animal. Larval stages are preferred for insects, for instance, grubs, maggots, mudeyes, caterpillars and mealworms. Mealworms are particularly preferred to make suitable food for a non-human animal, including both terrestrial animals such as poultry and aquatic animals such as finfish. Mealworms are especially preferred as food for poultry, particularly chickens, including broilers and layers. Mealworms are the larval form of darkling beetles. There are numerous species of darkling beetles, preferred species include Zophobas morio, Tenebrio molitor, Tribolium castaneum, Alphitobius diaperinus and Ulomoides dermestoides. Zophobas morio, Tenebrio molitor and Alphitobius diaperinus are particularly preferred. In some embodiments, the mealworm is Zophobas morio larva. In some embodiments, the mealworm is Tenebrio molitor larva. In some embodiments, the mealworm is Alphitobius diaperinus larva. Maggots are particularly preferred to make food for a non-human animal, including both terrestrial animals such as poultry and aquatic animals such as finfish. Maggots are especially preferred as food for finfish. Maggots are the larval form of flies. There are numerous species of flies, preferred species include Hermetia illucens and Musca domestica. Grasshoppers, crickets (preferably Acheta domesticus), locusts (preferably Locusta migratoria), cicadas, mealworms, caterpillars (preferably Bombyx mori) and grubs are preferred to make suitable food for a human. In some embodiments, an invertebrate is suitable to be fed a polyphenol composition, feed premix or feed of the invention to make a suitable food for an animal. In some embodiments, the invertebrate is an annelid. Earthworms and marine worms such as beach worms are preferred. Earthworms are preferred to make food suitable for non-human terrestrial animals, particularly poultry. Marine worms are preferred to make food suitable for aquatic animals, particularly finfish.

In some embodiments, the animal feedstock or human food is an insect. In some embodiments, the animal feedstock or human food is an invertebrate.

In some embodiments, the insect and/or invertebrate is an animal feedstock.

In some embodiments, the insect is an animal feedstock. In some embodiments, the invertebrate is an animal feedstock.

Animals suitable to be fed the insects and/or invertebrates fed the polyphenol composition, feed premix or feed of the invention include humans and non-human animals. In some embodiments, a human is to be fed the insects and/or invertebrates fed the polyphenol composition, feed premix or feed of the invention. In some embodiments, a non-human animal is to be fed the insects and/or invertebrates fed the polyphenol composition, feed premix or feed of the invention. Preferred non-human animals include insects, invertebrates, amphibians (particularly frogs), reptiles (particularly lizards and tortoises), birds (particularly companion birds, pigeons, and poultry, preferably poultry such as chickens, ducks, geese, turkeys and quails), finfishes (particularly carp, tilapia, catla, salmon, roho labeo, milkfish, tuna, trout, catfish, barramundi, turbot and eel), shellfishes (particularly crabs, crayfishes, lobsters, prawns and shrimps), monogastric animals (particularly pigs), ruminants (particularly cattle, sheep, goat and deer) and pseudo-ruminants (particularly horses, camels and rabbits). Birds and finfish are particularly preferred. In some embodiments, the animal is a bird. Poultry is preferred. Chickens are particularly preferred. In some embodiments, the chicken is a broiler. In some embodiments the chicken is a layer. Ducks are particularly preferred. Turkeys are particularly preferred. In some embodiments, the animal is a finfish. Tuna are particularly preferred. Salmon are particularly preferred. Trout are particularly preferred. In some embodiments, the animal is a pig. Animals propagated in agriculture, animals propagated in aquaculture and companion animals are preferred. In some embodiments, the animal is propagated in agriculture. In some embodiments, the animal is propagated in aquaculture. In some embodiments, the animal is a companion animal (particularly a dog, cat, fish, ferret, pig, rodent, lizard, tortoise, rabbit or bird). Dogs, cats, lizards and fish are preferred companion animals, with dogs and cats particularly preferred. In some embodiments, the animal is livestock.

The insect and/or invertebrate may be raised in growth media. In some embodiments, the growth media further comprises one or more of plant matter, animal matter and fungal matter. Plant matter is preferred, more preferably grain matter, even more preferably ground grain matter. Oats are preferred. Corn is preferred. Fungal matter is also preferred. In some embodiments, the growth media comprises one or more of leaf matter, grain matter, vegetable matter, fruit matter, meat, offal, mushroom matter and yeast. Leaf matter, grain matter, vegetable matter, fruit matter, mushroom matter and yeast are preferred. Agricultural waste streams are preferred, particularly vegetable and/or fruit production waste streams, more preferably fruit production waste streams such as pomace, more preferably apple pomace and/or grape pomace. Leaf matter is also particularly preferred, more preferably leaf matter capable of being grown on marginal land. Fungal matter such as yeast is preferred, with Brewer's yeast particularly preferred. Vegetable matter is also particularly preferred, particularly root vegetables such as carrots, potatoes or sweet potatoes. In some embodiments, the growth media further comprises one or more of sugar, carbohydrate, lipid (ie fat) and protein. The carbohydrate is preferably in the form of fibre. The sugar may be in the form of a composition such as molasses. Sugar and carbohydrate are preferred.

The polyphenol composition may be added to the growth media or may be a component of the growth media. Growth media may comprise wet food, preferably vegetable matter, fruit matter or leaf matter; more preferably one or more of apple, potato, sweet potato, carrot, pumpkin and cabbage. Wet food may be added periodically to the growth media. Further foods and/or nutritional boosters may be added to the growth media, for instance vitamin and/or amino acid supplement formulations (such as Solaminovit®), chicken layer pellets, calcium carbonate powder, chicken starter pellets, or dog or cat food. Preferably, the further food and/or nutritional booster is a vitamin and/or amino acid supplement formulation. Preferably, the further foods are added a week or two before feeding the insect and/or invertebrate to an animal or human.

In some embodiments, the growth media and/or polyphenol composition further comprises a waste stream from animal production or management. Waste streams from production include streams from raising such as streams comprising dung and/or partially eaten feedstock. Waste streams from management include waste streams from slaughter, such as one or more of offal, bone (preferably ground), blood and feathers. The inclusion of waste streams from animal production or management is preferred when the insect is a maggot. Waste streams from poultry (especially chicken production) and pig production are preferred.

Sugar Cane Vinasse and/or Digestate

Preferably, the sugar cane vinasse and/or sugar cane digestate is food grade and/or low odour. In some embodiments, the sugar cane vinasse and/or sugar cane digestate is food grade. In some embodiments, the sugar cane vinasse and/or sugar cane digestate is low odour. In some embodiments, the sugar cane vinasse and/or sugar cane digestate is food grade and low odour.

Optionally, the methane content of the sugar cane vinasse and/or sugar cane digestate is reduced. Optionally, the volatile organic compound content of the sugar cane vinasse and/or sugar cane digestate is reduced. Optionally, the volatile amine (including ammonia) and/or volatile mercaptan (including hydrogen sulphide) content of the sugar cane vinasse and/or sugar cane digestate is reduced.

The vinasse and/or digestate is optionally 500 to 5,000 mg GAE/100 g polyphenols, 500 to 3,000 mg/100 g polyphenols, 500 to 2,000 mg GAE/100 g polyphenols, 5,000 to 15,000 mg GAE/100 g polyphenols, 6,000 to 12,000 mg GAE/100 g polyphenols, about 10,000 mg GAE/100 g polyphenols or about 1,000 mg GAE/100 g polyphenols.

Optionally, the vinasse, digestate or vinasse digestate (ie a digestate of vinasse) has no odour or is odourless. Optionally, the vinasse, digestate or vinasse digestate has an odour intensity of 0-3 according to the VDI 3882-1 olfactometry standard. Alternatively, the vinasse, digestate or vinasse digestate has an odour intensity of 0-2, 1-3, 1-2, 2-3, 0, 1, 2, or 3 according to the VDI 3882-1 olfactometry standard for measuring odour intensity.

Alternatively, the polyphenol composition has no odour when combined with white refined sucrose to produce a 100 mg GAE polyphenol/100 g carbohydrate sugar. Alternatively, the polyphenol composition has no odour when combined with white refined sucrose or raw mill sugar to produce a 10, 15, 20, 30, 40 or 50 mg GAE polyphenol/100 g carbohydrate sugar. Polyphenol compositions meeting this test are reduced odour compositions of the invention.

The vinasse and/or digestate is optionally 10-15% ash. The vinasse and/or digestate is optionally ≤5 Pol % w/w, preferably ≤3 Pol % w/w, ≤1 Pol % w/w. The vinasse and/or digestate is optionally sugar free. The vinasse and/or digestate is optionally 20-25 μS/cm conductivity.

Optionally, the sugar cane vinasse or sugar cane digestate is not an extract. Optionally, the sugar cane vinasse or sugar cane digestate is a filtrate, preferably an affinity filtration filtrate such as an activated carbon filtrate and/or an ion-exchange resin filtrate.

In some embodiments, the vinasse has a Chemical Oxygen Demand (COD) of 30-150 (or 50-150) g O₂/L. The biochemical oxygen demand (BOD) is optionally about 30-80% of the COD. The COD/BOD ratio is optionally then 1.1-2 or 1.2-1.9.

In some embodiments, the vinasse includes 5-35% (or 5-20%) protein, 11-65% (or 15-30%) ash, 1-25 (or 5-25%) carbohydrates, 0-10% (or 1-6%) glycerol, and 30-85% (or 30-80%) water by weight. In alternate embodiments, the vinasse includes 70-85% moisture, about 10-20% ash, about 5-10% protein, under 1% carbohydrates. In some embodiments, the vinasse comprises water, organic solids, minerals (such as potassium, calcium, and magnesium) and polyphenols. In some embodiments, the vinasse comprises, 15-30% (or 20-25%) lignin, 8-20% (or 10-15%) cellulose, 5-10% hemicellulose ie one or more of a ratio of 1.5:1 to 6:1 or 2:1 to 5:1 lignin to hemicellulose, 0.8:1 to 4:1 or 1:1 to 3:1 cellulose to hemicellulose, and 0.75:1 to 3.75:1 or 1:1 to 3:1 or 1.3:1 to 2.5:1 lignin to cellulose by solid weight. Optionally, the vinasse includes the minerals phosphate, nitrate, sulphate, and/or calcium. Optionally, the vinasse further includes sodium and potassium. Optionally, the vinasse includes 500-1,500 mg/mL nitrate. Optionally, the vinasse includes 50-200 mg/mL phosphate. Optionally, the vinasse includes 500-4,000 mg/mL sulphate. Optionally, the vinasse includes 500-3,000 mg/mL calcium.

Optionally, the specific gravity of the vinasse is 0.5-2, 0.8-1.5 or 1-1.3 at 20° C. Optionally, the pH is 3.5-6.8, 3.5-5.0, 4.0-4.5, 4.9-5.4 or 5.4-6.8. Optionally, the vinasse is soluble. Alternatively, the vinasse includes 8,000-12,000 (or about 10,000) mg/l dissolved solids and optionally 4,000-5,000 (or 4,000-4,500) mg/l suspended solids. Optionally, the vinasse is 8-15 (or 10-13)° Brix (° Bx) at 28° C., has a relative density of 1-1.8 (or 1.2-1.4 (kg/l) at 20° C., a viscosity of about 75-125 (or about 100) cps at 20° C., and/or has a boiling point over 80 or 100° C.

In some embodiments, the vinasse has a dry matter content of 40-60 or 45-50% by weight.

In some embodiments, the sugar cane vinasse digestate has a pH of 6.5 to 9.5. For a solid digestate, the pH is the pH of a 10% w/v solution of the digestate in water. Optionally, the digestate is 5-20% w/w or 10-15% w/w ash. Optionally, the digestate is less than 1% or less than 0.5% or less than 0.01% digestible carbohydrate including sugar.

Optionally, the sugar cane vinasse digestate had 9-11% solids as determined by a Brix Meter.

The sugar cane vinasse digestate also had less than 1 mg/kg arsenic, less than 0.30 mg/kg antimony; less than 0.03 mg/kg cadmium, 1.9 mg/kg selenium; less than 0.004 mg/kg mercury; and 0.12 mg/kg lead.

### Vinasse or Dunder

Vinasse and dunder are both terms for an effluent byproduct of the sugar and ethanol industries. It is produced when carbohydrate is fermented to produce alcohol (during, for example bioethanol production or the production of rum) or amino/organic acid (eg ascorbic acid) or to propagate yeast. Specifically, it is a byproduct of the distillation step subsequent to fermentation of carbohydrates obtained from different sources of saccharides materials (eg sugarcane, sugar beet, starchy materials and lignocellulose materials). For example, vinasse is the liquid left in the boiler after distilling a batch of rum. Vinasse contains high organic matter concentrations. For the purposes of this invention the carbohydrate source includes polyphenols such as sugar cane juice or sugar cane molasses. As bioethanol production increases, the amounts of vinasse increase and alternate methods to dispose of the vinasse are in need.

Vinasse is the remaining biomass and yeasts after distillation of bioethanol produced through fermentation. Commercial fermentation is performed on a carbohydrate-rich feedstock where the carbohydrate is easily accessible. Fermentation is a process that typically begins aerobically but becomes anaerobic, leading to production of ethanol. This production of ethanol selects microorganisms (mainly yeasts) that are able to grow in an alcoholic environment. Most yeasts can only tolerate a maximum alcohol percentage of 10-15%. Accordingly, the yeast cells die before the population can move on to fully digest the food sources in the mixture that are less readily accessible than easily accessible carbohydrates.

Vinasse can be obtained from sugar and bioethanol producers.

### Fermentation of Molasses

Molasses is optionally transferred from storage tanks to a fermentation tank where it is tested for pH, bacterial, and essential mineral levels. Sulfuric acid is used to adjust and maintain the pH level during fermentation. Water and yeast are added to the molasses mixture to start fermentation. The molasses mixture is allowed to ferment (eg for 12-40 hours) for (i) ethanol propagation for rum and industrial grade alcohol, biofuel; (ii) yeast propagation; and (iii) amino/organic acid production. Ammonium compounds or yeast extracts may also be used to raise the nitrogen level of the solution to required levels necessary for fermentation.

A similar process can be used to ferment sugar cane juice.

### Alcohol Distillation

After fermentation, the yeast, which has settled to the bottom of the tank, is separated from the liquor mixture. The separated liquor mixture is fraction distilled.

Batch distillation may be performed with various types of well-known equipment. The simplest form is a single simple pot still. The fermented product (often referred to as beer) is heated in a pot fitted with a vapor pipe, which leads to a condenser coil immersed in a water tank. As the beer is heated, the alcohol and other volatile congeners are distilled off, condensed, and run into a storage tank. The process is continued until most of the alcohol has been distilled out.

The residue, or stillage, is emptied out of the pot and the distillate is optionally returned from the storage tank to the pot to be redistilled to increase the proof. The stillage is also known as vinasse or dunder. This vinasse can be included in sugars of the invention. The vinasse can also be further processed to vinasse digestate and/or to reduce its odour to prepare a polyphenol composition of the invention.

Fermentation and distillation of sugar cane can generate ten times the volume of vinasse to the ethanol produced.

### Yeast Propagation

Yeast propagation can also follow the fermentation process.

Yeast cells are grown in a series of fermentation vessels. Yeast fermentation vessels are operated under aerobic conditions. Once the optimum quantity of yeast has been grown, the yeast cells are recovered at the final fermentation stage by centrifugal yeast separators. Vinasse is the remains of the feedstock after the final fermentation stage.

Vinasse can then be used as feedstock in biofuel production, as an agricultural fertilizer and soil conditioner, to prepare polyphenol containing sugars, or further processed to vinasse digestate and/or to reduce its odour.

### Vinasse Composition

Vinasse is mainly of plant origin, with some microbial residue (yeast). It components vary based on the starting material used. The components of vinasse are readily metabolized and utilized by microorganisms as energy sources. Vinasse is a dark brown liquid that can have a boiling point of over 100° C., a relative density at 20° C. (kg/l) of about 1.33, a viscosity of about 100 cps at 20° C. and forms an infinite aqueous solution is water.

The vinasse from sugar cane juice is acidic (reported as pH 3.5-5.4 but also as 5.4 to 6.8), predominantly soluble (eg about 80% soluble or more) and has an organic matter concentration (Chemical Oxygen Demand (COD) of 50-150 g O₂/L). The biochemical oxygen demand (BOD) can be about 75% of the COD. COD/BOD ratios can be about 1.3 indicating high biodegradability. This makes vinasse suitable for anaerobic digestion. Vinasse can have 1230±630 mg/L of nitrogen, 190±35 mg/L phosphorus, 3500±2500 mg/L sulfate (See Naspolini 2017). Vinasse also contains the macronutrients required for microorganisms in anaerobic digestion. Vinasse can be processed to prepare digestate.

The vinasse assessed in Ahmed 2013 at 28.33° C. was 11.02° Brix, 22.9 μs/com conductivity, pH 4.31 10500 mg/l dissolved solids, 4633 mg/l suspended solids and contained 1735 mg/l calcium, 86 mg/l copper, 17 mg/l Iron (Fe), 14 mg/l manganese, 0.01 mg/l aluminium, 820 mg/l sulphate (SO₄), 78 mg/l phosphate (PO₄), and 600 mg/l nitrate (NO₂) but was devoid of all microbial groups, which is expected following the distillation processing temperatures. Molasses vinasse had a COD 48 g O₂/L and BOD 25.8 g O₂/L. The COD/BOD ratio was then 1.86 with lower biodegradability than the Naspolini 2017 sugarcane juice vinasse. The vinasse was about 82% moisture, about 10% ash, about 6% protein and under 1% carbohydrates. In Brazil vinasse from sugar cane juice and molasses has been reported as having about 15% and about 20% ash respectively indicating that content can vary based on the region from which the sugarcane juice, molasses or other carbohydrate used to produce ethanol is sourced.

According to Devia-Orjuela (2019), vinasse is characterized by low pH values, high chemical oxygen demand (COD: 32,000-109,700 mg/L), and biological oxygen demand (BOD: 13,414-87,700 mg/L). Vinasse is composed mainly of water; organic solids; and minerals like potassium, calcium, and magnesium. Powdered vinasse was found to have 23% lingnin, 12.7% cellulose and 8.7% hemicellulose.

Vinasse includes some sugars (for example, fructose, and/or galactose) and sugar alcohols (for example, mannitol, xylitol, and/or dulcitol). Sugar alcohols are produced as byproducts of the ethanol-producing yeasts used to generate the ethanol and vinasse. Vinasse can be, for example, 8-12 or 10° Brix. This makes vinasse suitable for further anaerobic digestion.

### Commercially Available Vinasse/Dunder

BioDunder® is a liquid by-product of ethanol that is produced using the Biostil fermentation/distillation process at Wilmar BioEthanol's Sarina Distillery, Queensland, Australia. BioDunder, (which contains approximately 30-40% solids) is the end product of molasses fermentation (following distillative removal of alcohol) and comprises vegetable matter (yeast biomass) containing potassium, sodium, nitrogen, calcium, magnesium, phosphorous and sulphur. Biodunder® is a dark, brown/black viscous liquid generally containing 5-35% protein, 11-65% ash, 5-25% carbohydrates, 1-6% glycerol, and 30-80% water by weight. It generally has a pH of 4.0-4.5 and a specific gravity of about 1.12 at 20° C. The glycerol is added to the raw dunder to prepare the commercial product. For the purposes of this invention, it is preferable to source the dunder prior to addition of the glycerol and/or remove the glycerol prior to use of the dunder in the methods of the invention or to prepare the vinasse/digestate of the invention.

### Digestate

Digestate is the liquid remnants of the original input (ie feedstock) material following microbial digestion including, in particular, anaerobic digestion. Polyphenols remain in the digestate.

Any product of anaerobic digestion of biodegradable feed stocks (including vinasse) could be considered a digestate. However, in industry, digestate often, in context, refers to the product of an anaerobic digestion of feed stocks lacking high levels of easily accessible carbohydrate. The digestate remaining following digestion of a low accessible carbohydrate feedstock (such as vinasse) is different to vinasse. Digestion in low carbohydrate/low alcohol conditions leads to different volatile products being produced through anaerobic digestion, mainly biogas. As opposed to the formation of alcohol during fermentation of compositions high in easily digestible carbohydrates (such as sugar cane juice).

Digestate pH varied between 6.5 to 9.5 whereas vinasse pH may be as low as 3.5 due to higher content of residual organic and volatile acetic acids from fermentation including acetic, fulvic and aconitic acids which form very stable mineral chelates of boron, calcium, copper, iron, manganese, zinc.

### Anaerobic Digestion

Anaerobic digestion is widely used as a source of renewable energy. The process produces a biogas, consisting of methane, carbon dioxide, and traces of other ‘contaminant’ gases. This biogas can be used directly as fuel, in combined heat and power gas engines or upgraded to natural gas-quality biomethane. Anaerobic digestion also produces a nutrient-rich digestate byproduct that can be used as fertilizer. Anaerobic digestion is used as part of the process for treating biodegradable waste. Anaerobic digesters can also be fed with purpose-grown energy crops, such as sugar cane.

Anaerobic digestion is a staged process. The stages are as follows:
Hydrolysis: breakdown of complex insoluble organic matter into simple sugars, fatty acids, and amino acid.
Acidogenesis: further breakdown of simple sugars, fatty acids, and amino acids into alcohols & volatile fatty acids (VFAs).
Acetogenesis: conversion of VFAs and alcohols into acetic acid, CO₂, and hydrogen.
Methanogenesis: acetic acid and hydrogen are converted into methane and CO₂ by methanogenic bacteria.

There are mesophilic, acidophilic and thermophilic anaerobic digestion systems.

The digestion process begins with bacterial hydrolysis of the input materials (for example vinasse) in order to break down insoluble organic polymers such as carbohydrates (eg lignin, cellulose and hemicellulose) and make them available for other bacteria. Acidogenic bacteria then convert the sugars and amino acids into carbon dioxide, hydrogen, ammonia, and organic acids. Acetogenic bacteria then convert these resulting organic acids into acetic acid, along with additional ammonia, hydrogen, and carbon dioxide. Finally, methanogens convert these products to methane and carbon dioxide.

Various versions of anaerobic digestion are in commercial use and are considered suitable to prepare digestates of the invention.

### Batch or Continuous

Anaerobic digestion can be performed as a batch process or a continuous process. In a batch system, biomass is added to the reactor at the start of the process. The reactor is then sealed for the duration of the process. In its simplest form batch processing needs inoculation with already processed material to start the anaerobic digestion.

In continuous digestion processes, organic matter is constantly added (continuous complete mixed) or added in stages to the reactor (continuous plug flow; first in-first out). Here, the end products are constantly or periodically removed, resulting in constant production of biogas. A single or multiple digesters in sequence may be used. Examples of this form of anaerobic digestion include continuous stirred-tank reactors, upflow anaerobic sludge blankets, expanded granular sludge beds, and internal circulation reactors.

In preferred embodiments, a continuous digestion process is used to prepare digestates of the invention.

### Vinasse Digestate

Vinasse digestate is the non-volatile materials that remain after fermentation and distillation to produce vinasse and then further anaerobic digestion. Optionally, the further anaerobic digestion is after the initial volatiles have been removed. This process involves anaerobic digestion in an environment with substantial alcohol and then anaerobic digestion in a substantially-alcohol free or low alcohol environment.

In preferred embodiments, the polyphenol composition of the invention is sugar cane vinasse digestate. Either sugar cane juice or molasses is fermented and then distilled to produce ethanol. The vinasse by-product of this process is then fed into an anaerobic digestor to produce biogas. Optionally, this is a continuous digestor that only requires inoculation at the beginning of ethanol production season.

The anaerobic digestor converts vinasse into biogas (gas), digestate (liquid) and sludge (solid). Some sugar cane mills that produce ethanol also have a digestor onsite that is essentially a covered lagoon. Biogas is captured under the covers and continuously vented from the digestor, dried and compressed to use as a fuel source. Digestate overflows into a digestate well and is pumped out to a storage facility. Sludge builds up in the digestor and is removed as needed. This can be as infrequently as once at the end of the season.

Digestors of 140,000 m³ can be used at a consistent incoming flowrate of 100 kL/day per digestor. No water is added, however the incoming total solids from vinasse production can vary. Temperature is ambient, which during the 4-5 month long season is 25-35° C. Residence time in the lagoon is approximately 100 days.

### Drying and Reconstituting

If needed, the vinasse and/or digestate is optionally concentrated to 30-50° Brix (eg about 40° Brix).

The vinasse and digestate can both be spray dried, for example, for easy transport. The powdered form is relatively stable and easier to transport. Dried vinasse and/or digestate can be combined into a premix or feed of the invention. Alternatively, the vinasse and/or digestate powder concentrate can be reconstituted into liquid form with either water or affination syrup (for example, in a 1:10 ratio or to about 10° Brix) and then premix or feed of the invention. Direct consumption of the dried or reconstituted vinasse and/or diestate is also possible but combination in a food or drink is expected to be most convenient.

### Polyphenol Content Measurement

Polyphenol content can be measured in terms of its catechin equivalents or in terms of its gallic acid equivalents (GAE). Amounts in mg CE polyphenols/100 g can be converted to mg GAE polyphenols/100 g by multiplying by 0.81 ie 60 mg CE polyphenols/100 g is 49 mg GAE polyphenols/100 g.

A laboratory method for determining polyphenol content is described in Kim, Dae-Ok (2003).

### Odour Measurement

There are various methods for measuring odour. These methods are both sensory and instrumental. The testing used in this specification has been informal sensory testing and is explained in the examples, definitions and throughout the specification as appropriate. More formal testing can be conducted by dynamic olfactometry.

Dynamic olfactometry is a sensorial method standardized by the European Standard EN13725: 2003 (Standard EN 13725:2003. Air Quality-Determination of Odour Concentration by Dynamic Olfactometry; CEN: Brussels, Belgium, 2003), which provides the odour concentration of a sample, referring to the sensation that it causes in a panel of opportunely selected people directly exposed to that odour.

The odour concentration, expressed in European odour units per cubic meter (ouE/m³), represents the number of dilutions with neutral air that are necessary to bring the concentration of the sample to its odour detection threshold (OT), i.e., the threshold at which the odour is perceived by 50% of the examiners. To put it in the simplest manner, if the sample needs to be diluted 100 times with clean air so that the panel cannot perceive the odor anymore, this means that the sample has a concentration of 100 ouE/m³.

The analysis is carried out by presenting the sample to the examiners (i.e., panelists) at increasing concentrations by means of a dilution device, called an olfactometer, which dilutes the samples according to given ratios with reference air, which is made odour- and humidity-free through filtration with active carbon or silica gel.

In order to ensure reliable and repeatable results, the EN 13725:2003 fixes precise criteria for panel selection based on individuals' threshold for n-butanol in nitrogen (between 20 and 80 ppb) and the standard deviation of the individual's responses, which are verified periodically.

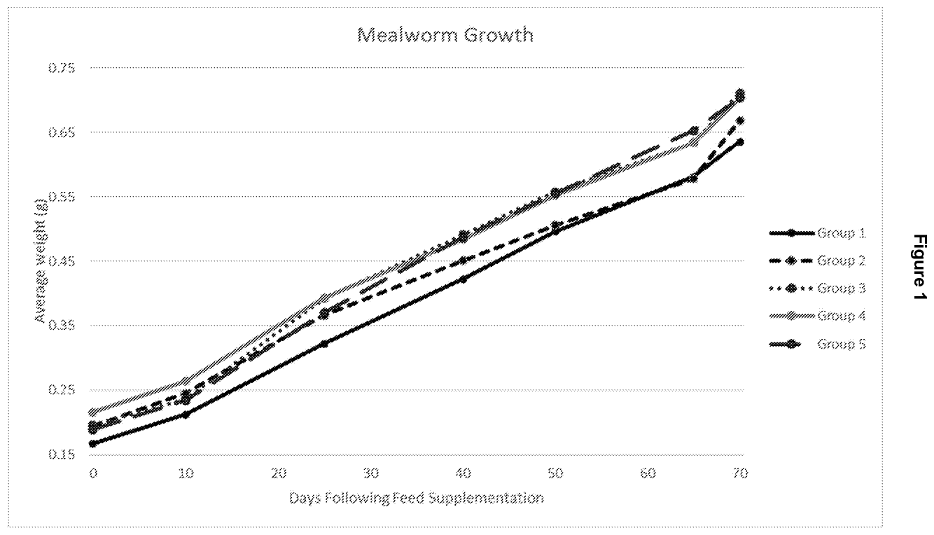

German guidelines VDI 3882 Part 1 (Blatt 1:1992, Olfactometry; determination of odour intensity) and VDI 3882 Part 2 (1994, Olfactometry-determination of hedonic odour tone), describe how to apply olfactometric measurements for the determination of odour intensity and odour pleasantness/unpleasantness (hedonic tone). Odour intensity is expressed in a scale from 0 (not perceptible) to 6 (extremely strong). Hedonic tone is measured in a scale from −4 (extremely unpleasant) to +4 (extremely pleasant) (FIG. 1).

The odour intensity scale is not perceptible (0), very weak (1), weak (2), distinct (3), strong (4), very strong (5), or extremely strong (6). The sugar cane vinasse or sugar cane digestate starting material can be distinct, strong, very strong or extremely strong in odour (ie a 3-6). The reduced odour polyphenol compositions of the invention are not perceptible, very weak, weak, or distinct in odour (ie a 0-3) in the odour intensity scale. The original digestate, vinasse or vinasse digitate is strong, very strong, or extremely strong in odour (ie 4-6).

### Cane Juice

Cane juice contains all the naturally occurring macronutrients, micronutrients and phytochemicals present in the syrup extracted from pressed and/or crushed peeled sugar cane that are normally removed in white refined sugar, which is 99.9% sucrose.

### Arsenic Reduction

If the arsenic levels of the vinasse or digestate are too high, they can be reduced by known methods including use of calcium-alginate beads (see Bezbaruah 2014).

### REFERENCES

Ahmed, O et al, Physiochemical, Chemical and Microbiological Characteristics of Vinasse, a by-product from ethanol industry, American Journal of Biochemistry (2013) 3 (3): 80-83.
Bezbaruah, A. N. et al, Ca-alginate-entrapped nanoscale iron: arsenic treatability and mechanism studies, Journal of Nanoparticle Research (2014) 16:2175.
Devia-Orjuela, J. S. et al, Evaluation of press mud, vinasse powder and extraction sludge with ethanol in a pyrolysis process, Energies (2019) 12:4145.
Kim, Dae-Ok, et al, Antioxidant capacity of phenolic phytochemicals from various cultivars of plums, Food Chemistry (2003) 81, 321-26.
Naspolini, B. F. et al, Bioconversion of sugarcane vinasse into high-added value products and energy, BioMed Research International (2017) article ID 8986165.
International patent application number PCT/SG2020/050777.

A copy of each of these is incorporated into this specification by reference.

### EXAMPLES

### Example 1—Weight Gain of Mealworms Fed a Polyphenol Composition

Mealworms (Zophobas morio larvae) (100 in each group) were raised in a box that initially contained 200 g of a growth media supplemented with compositions that contained varying amounts of polyphenols. The 200 g growth media was made up of 190 g of apple pomace, 5 g of Solaminovit® and 5 g of oats. The growth media was renewed every week of the trial to the same amount as the starting mass. The compositions that contained varying amounts of polyphenols were added in consistent daily amounts to their respective groups, such that over 70 days a total mass of 100 g of the compositions were added to their respective groups. The make-up of the compositions for each group is detailed in Table 1. The polyphenol composition comprised deodorised sugar cane digestate with a polyphenol level of approximately 10,000 mg GAE/100 g.

Brewer's yeast is commonly used as a meal worm feed additive due to containing around 8% protein. Apple pomace is the solid residue that remains after milling and pressing of apples for cider, apple juice or puree production. Apples contain over 60 different phenolic compounds. The major phenols include benzoic acids (gallic acid) and flavonols (rutin C). Saltbush (Atriplex sp.) are a family of hardy shrubs, many of which are native to Australia and are increasingly being used as a stockfeed.

Different compositions with different polyphenol contents were trialled on different groups of mealworms. The individual weights of the mealworms of groups fed the different polyphenol compositions were compared at a 5 day interval to a control group fed growth media in the absence of a polyphenol composition. The results are plotted in FIG. 1. No significant difference in mealworm mortality was observed.

After 70 days of raising (taken from the beginning of supplementation) the average weights of each group of mealworms was as tabulated in Table 1. Every group fed a polyphenol composition exhibited an increase in average weight over the control lacking a polyphenol composition. The group fed 30% polyphenol exhibited an increase of approximately 16% over the control.

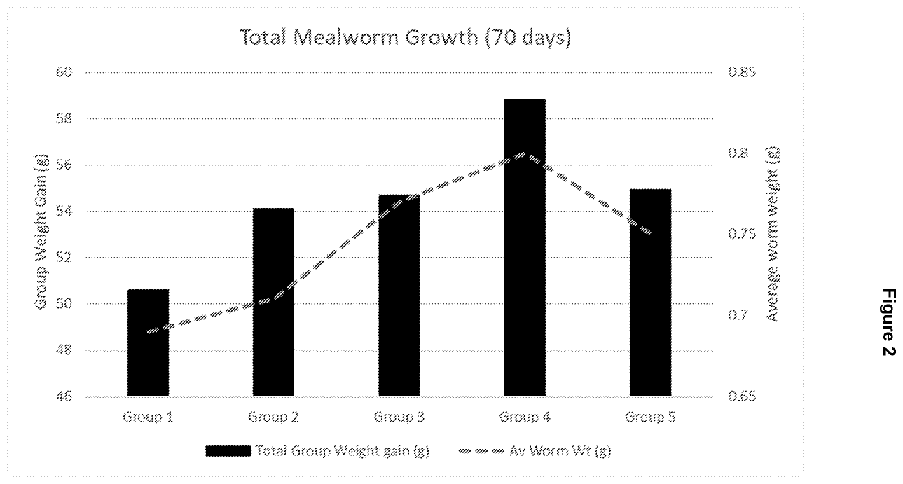

Total weight gains for each group are depicted in FIG. 2. Group 4 was observed to perform better in total group weight gain and individual worm weight gain over the trial period. Group 2 appeared to demonstrate inconsistent individual worm growth with when compared to the other groups fed a polyphenol composition.

TABLE 1
Comparison of average weight of mealworms after 70 days of raising

| | | | | | | Average % |
|---|---|---|---|---|---|---|
| | | | | | | increase in |
| | Group specific | Total | | Average | | meal worm |
| | component of | mealworm | | mealworm | | weight |
| Group | composition | weight | | weight | | over control |
| 1 | Control (no polyphenol | 50.9 | g | 0.69 | g | nil |
| | composition) (50 g saltbush, | | | | | |
| | 50 g Brewer's yeast) | | | | | |
| 2 | 1% polyphenol composition | 54.1 | g | 0.71 | g | 3% |
| | (49 g saltbush, 50 g | | | | | |
| | Brewer's yeast, 1 g | | | | | |
| | polyphenol composition) | | | | | |
| | le about 100 GAE mg/100 g | | | | | |
| | polyphenols in the feed | | | | | |
| | supplement due to the | | | | | |
| | polyphenol composition | | | | | |
| | or 50 GAE mg/100 g | | | | | |
| | of the whole feed | | | | | |
| | (including the growth media) | | | | | |
| 3 | 10% polyphenol composition | 54.6 | g | 0.77 | g | 12% |
| | (40 g saltbush, 50 g | | | | | |
| | Brewer's yeast, 10 g | | | | | |
| | polyphenol composition) le | | | | | |
| | about 1,000 GAE mg/100 g | | | | | |
| | polyphenols in the feed | | | | | |
| | due to the polyphenol | | | | | |
| | composition or 500 GAE | | | | | |
| | mg/100 g of the whole feed | | | | | |
| | (including the growth media) | | | | | |
| 4 | 30% polyphenol composition | 58.8 | g | 0.80 | g | 16% |
| | (20 g saltbush, 50 g | | | | | |
| | Brewer's yeast, 30 g | | | | | |
| | polyphenol composition) le | | | | | |
| | about 3,000 GAE mg/100 g | | | | | |
| | polyphenols in the feed due | | | | | |
| | to the polyphenol | | | | | |
| | composition or 1,500 GAE | | | | | |
| | mg/100 g of the whole feed | | | | | |
| | (including the growth media) | | | | | |
| 5 | 50% polyphenol composition | 54.9 | g | 0.75 | g | 9% |
| | (50 g Brewer's yeast, 50 g | | | | | |
| | polyphenol composition) le | | | | | |
| | about 5,000 GAE mg/100 g | | | | | |
| | polyphenols in the feed | | | | | |
| | due to the polyphenol | | | | | |
| | composition or 2,500 GAE | | | | | |
| | mg/100 g of the whole feed | | | | | |
| | (including the growth media) | | | | | |

Addition of the 30% polyphenol composition resulted in a media that was more free flowing than the addition of 50% polyphenol composition. A more free flowing composition is preferred.

### Example 1a—Moisture Content of Mealworms

Groups of mealworms were raised according to Example 1 with the exception that they were raised for 90 days rather than 70 days.

The moisture content of each group was assessed upon completion of the trial. On trial completion worms were deep frozen and dried for 48 hours at 45° C. in a cyclic cycle dryer. Groups fed a diet with a higher polyphenol content led to an increase in moisture content and an increase in dry weight over the control. The group fed the 50% polyphenol composition had the greatest increase in dry weight over the control. The results are tabulated in Table 2.

TABLE 2
Comparison of the moisture content of the meal worm groups fed
different levels of the polyphenol composition for 90 days

| | Weight of | Dry weight | | |
|---|---|---|---|---|
| | worms of | of worms of | | |
| | group after | group after | | Dry weight |
| | 90 days of | 90 days of | % moisture | increase over |
| Meal worms | raising (g) | raising (g) | loss | control |
| Group 1 | 75.36 | 31.25 | 58.53% | nil |
| Group 2 | 80.00 | 32.15 | 59.81% | 3.2% |
| Group 3 | 80.52 | 32.27 | 59.92% | 3.2% |
| Group 4 | 81.14 | 32.09 | 60.45% | 2.7% |
| Group 5 | 83.49 | 32.45 | 61.13% | 3.9% |

### Example 2—Polyphenol Content of Mealworms Feeds

The polyphenol assay was based on the Folin-Ciocalteu method and was modified from the method of Kim et al (2003).

Polyphenol compounds can be free (water soluble) or bound within the sample—this requires different extraction methods and solvents. The method that produced the highest result is presented here. Procedures and results are tabulated in Table 3.

Trial 7 samples were extracted as follows. 0.4 g of each sample was extracted with 50 ml dist. H₂O at 60° C. agitated by shaking platform for 30 mins. The mixture was made up to 100 ml with dist. H₂O before being filtered through Whatman's #41.

Trial 9 samples were extracted as follows. 0.3 g of each sample was extracted with 10 ml dist H₂O. All treatments were heated to 80° C. for 45 mins, agitated every 5 mins, before being filtered through Whatmans #41.

Meal worm feed polyphenol content (GAE mg/g) increased with addition of the polyphenol composition.

TABLE 3
Polyphenol content of mealworm feeds of Example 1

| | mg GAE/ 100 g Meal Worm Feed | | | |
|---|---|---|---|---|
| | | % increase | Trial 9 | % increase |
| Group | Trial 7 | over control | (repeat extraction) | over control |
| 1 | 400 | nil | 410 | nil |
| 2 | 610 | 53% | 540 | 32% |
| 3 | 1300 | 225% | 1250 | 205% |
| 4 | 2970 | 643% | 3000 | 632% |
| 5 | 4460 | 1015% | 5690 | 1288% |

The polyphenol content of the base apple pomace, base worm pomace media and salt bush powder used in Example 1 was analysed as described in Table 4. Apple pomace worm base media GAE extraction results were higher using ethanol extraction.

TABLE 4
Polyphenol content of base components of mealworm feeds of Example 1

| | mg GAE/ | | |
|---|---|---|---|
| | 100 g | | |
| | Extraction | | |
| | Solvent | | Comments |
| Base Feed | H₂0 | EtOH | Trial 11 - Meal worm Feed extraction |
| Base Apple Pomace | 80 | 220 | 0.5 g of each sample was extracted with 10 ml |
| Base Worm Pomace | 80 | 230 | dist. H₂O or 72% EtOH (v/v). The mixture was |
| Media | | | heated to 80° C. for 45 min, agitated every 5 min, |
| Salt Bush powder | 320 | 450 | before being filtered through Whatmans #41. After |
| | | | filtration, the filtrate was made up to the original |
| | | | solvent volume. |

### Example 3—Polyphenol Content of Frass from Mealworms of Example 1

The polyphenol content of the frass generated by each group of Example 1 was analysed as described in Table 5. In general, polyphenol content of the frass (GAE mg/g) increased with addition of the polyphenol composition.

TABLE 5
Polyphenol content of frass generated by groups of Example 1

| | mg GAE/ | | Comments |
|---|---|---|---|
| | 100 g | % change | Trial 6 Frass |
| Group | Trial 7 | over control | sample extraction |
| 1 | 530 | nil | 0.5 g of each frass sample |
| 2 | 420 | −21% | was extracted with 10 ml dist. |
| 3 | 530 | nil | H2O. The mixture was heated |
| 4 | 970 | 83% | to 80° C. for 45 mins, agitated |
| 5 | 1530 | 189% | every 5 mins, before being |
| | | | filtered through Whatmans # 41. |

### Example 4—Properties of Liquid Dunder & Digestate Compositions

Liquid sugar cane juice vinasse digestate commercially sourced from a bioethanol manufacturer in Thailand was analysed for phenolic content by both CE and GAE methods. The results were 1.000% w/w as catechin equivalents (1000 mg CE/100 g) or 0.810% w/w as gallic acid equivalents (809.8 mg GAE/100 g).

Several samples of brown to dark brown liquid digestate from different batches were obtained. The digestate used had 9-11% solids as determined by a Brix Meter. The digestate also had 0.94 mg/kg arsenic, less than 0.30 mg/kg antimony; less than 0.03 mg/kg cadmium, 1.9 mg/kg selenium; less than 0.004 mg/kg mercury; and 0.12 mg/kg lead. The digestate has a six month to one year shelf life depending on storage conditions.

### Example 5—Spray Drying Liquid Digestate or Dunder

Sugar cane juice vinasse digestate was commercially sourced from a bioethanol manufacturer in Thailand in liquid form and spray dried to powder form (inlet temperature 160° C. & outlet temperature 80° C.).

The spray drying can be either before or after further processing with activated carbon as described in Example 6 below.

The spray dried digestate was pH tested. The results for two samples was pH 9.2 & 9.5 when 1 g of powder was dissolved in 10 ml water.

The properties of the vinasse digestate powders D1 to D3 are in Table 6. The three digestate samples were assessed for sucrose sugar content by polarisation using HPLC and near infra-red (NIR pol), for conductivity using a conductivity meter, for ash levels using NIR (NIR ash), for colour levels using NIR (NIR colour), for polyphenol levels using a Folin-Ciocalteu laboratory method with UV detection at 760 nm (adapting method from Kim et al for determining mg GAE polyphenols/100 g carbohydrates (Lab GAE). The NIR results were all determined using standard titration methods to correlate NIR reading with ash, colour, polyphenol and other results.

TABLE 6
Properties of a number of digestate powders

| | NIR | Conduc- | NIR | NIR | Lab GAE |
|---|---|---|---|---|---|
| | Pol | tivity | Ash | Color | mg GAE/ |
| Sample ID | % w/w | μ s/cm | % w/w | ICUMSA | 100 g |
| Digestate | BDL | 21.9 | 11 | 11106 | 6818 |
| composition | | | | | |
| 1 (D1) | | | | | |
| Digestate | <1 | 23.2 | 13 | 7805 | 10789 |
| composition | | | | | |
| 2 (D2) | | | | | |
| Digestate | BDL | 24.3 | 11 | 7981 | 11273 |
| composition | | | | | |
| 3 (D3) | | | | | |

The spray dried digestate of the invention is preferably soluble in water. Where the dunder or digestate used to prepare the spray dried powder has an insoluble fraction, the insoluble fraction is preferably removed before spray drying.

Spray dried sugar cane juice vinasse digestate powder was provided to the National Measurement Institute in Australia for analysis. The powder had a standard plate count of 12,000 CFU per g, less than 10 yeast CFU per g, less than 40 mould CFU per g and 1,500 aerobic thermophilic bacterial spores CFU per g.

Based on the results to date, the product specifications for spray dried digestate of the invention are proposed to be as set out in Table 7 below.

TABLE 7
Polyphenol composition specifications

| Chemical Name | Proportion | |
|---|---|---|
| Plant Fibre | <40% | w/v |
| Ash | <35% | w/v |
| Polyphenols | >7% | w/v |

| Parameter | Specification | |
|---|---|---|
| Appearance | Fine Powder | |
| Moisture | ≤5.0% | |
| pH 10% w/v | 9-9.5 | |
| Polyphenols | >7000 mg/100 g GAE | |
| Heavy Metals | <2 | mg/kg |

Microbiological Properties

| | | |
|---|---|---|
| Total Plate Count | ≤15,000 | CFU/g |
| Yeast and Mould | ≤1,500 | CFU/g |

| | |
|---|---|
| Salmonella | Absent |

The spray dried powder generally has less than 2% w/w moisture.

The brown to dark brown fine powder has ≤2.0 mg/kg arsenic, cadmium and selenium; ≤1.0 mg/kg mercury; and ≤0.2 mg/kg lead. The powder is ≤6.0% and has a bulk density of 0.7-0.85 kg/L. The powder has the following microbiological properties: total plate count of ≤15,000 CFU/g, yeast of ≤500 CFU/g and no salmonella.

Following the above invention, spray drying was also conducted with sugar cane digestate concentrated to 25 brix. The concentrate is passed through an evaporator at 80° C. for 1 minute and then pumped into the spray dryer. This process produces acceptable dry powder.

### Example 6—Further Processing Digestate by Activated Carbon to Reduce Odour

The effect on odour and GAE levels for polyphenols upon contact of digestate with powdered activated carbon (PAC) was studied.

The loose PAC was pre-washed prior to the tests. 400 g of PAC was pre-washed with 1 L of distilled water to remove carbon dust. The water was decanted and discarded and replaced with fresh distilled water at regular intervals over a 48 hour period until the water was no longer coloured. At this point, the water was discarded and carbon was dried in an oven at 100° C. until the carbon was desiccated to powder form.

Spray dried digestate powder (20 g) was mixed with distilled water and made up to 100 ml volumetrically. 5×5 ml aliquots of this mixture were taken. 0.4 g of washed PAC was added to four of these aliquots. All five aliquots were made up to 100 ml volumetrically. All five diluted flasks were placed on a mechanical stirrer and agitated for mixing according to an assigned PAC contact time (0, 15, 30, 45, 60 min). The sample with a PAC contact time of 0 min was the sample where PAC was not added.

Upon mixing and after the nominated PAC contact time had elapsed, the samples were filtered through Whatman 41 (0.22 μm) filter paper. Filtered subsamples were analysed for polyphenol content according to Kim et al. Unfiltered samples with a PAC content time of 0 min were also analysed for polyphenol content according to Kim et al. The odour of the filtered subsamples was also assessed by a panel of 4 people.

The results of this testing is tabulated below in Table 8. Odour was found to decrease with increased PAC time. GAE levels did not greatly decrease with increased PAC time.

TABLE 8
PAC contact time vs GAE levels and sensory profile

| | PAC | | | | | Sensory |
|---|---|---|---|---|---|---|
| | contact | | | Dilution | GAE mg/ | Analysis |
| Sample | time | | Filtered | for assay | 100 g | (4 people) |
| 1 | 0 | min | No | 1/100 | 11423 | earthy smell |
| 2 | 0 | min | No | 1/200 | 10073 | earthy smell |
| 2 | 0 | min | Yes | 1/200 | 10202 | earthy smell |
| 3 | 15 | min | Yes | 1/200 | 9329 | moderate |
| | | | | | | earthy smell |
| 4 | 30 | min | Yes | 1/200 | 10566 | slight earthy |
| | | | | | | smell |
| 5 | 45 | min | Yes | 1/200 | 10022 | no odour |
| 6 | 60 | min | Yes | 1/200 | 9842 | no odour |

Spray dried activated carbon processed digestate stored in clear, sealed, plastic bags has a shelf life of 6 months to 1 year.

### Example 7—Further Processing of Digestate to Reduce Odour

The effect of activated carbon on odour and turbidity for sugar cane juice vinasse digestate was further studied. The testing was conducted by SLS Global Technical Support of Pall Corporation in Bangkok, Thailand.

Liquid vinasse digestate of 44° and 10° brix was commercially sourced as starting material. These samples had a dark brown colour and strong odour from organic compounds. The 44° brix sample had high viscosity. The 10° brix sample had low viscosity.

### Reduction in Turbidity

The 10° brix sample was pre-filtered using Seitz® K900 sheet filter at a flow rate of 15 ml/min (Flux rate 400 LMH) at 25° C. with filtrate volume 700 ml at differential pressure 2.0 bar. Seitz® K900 sheet filters are 4.3 mm thick sheets made of cellulose, diatomaceous earth and perlite. The K900 is 46% ash with water permeability of 1700 L/m²/min. The turbidity value decreased from 70.5 NTU to 50.6 NTU with no effect on the odour. Odour was inspected manually by the conductor of the test smelling the sample. See Table 9 below.

TABLE 9
Result of trial with 10° brix sample pre-filtered
using Seitz ® K900 sheet filter at a
flow rate of 15 ml/min (Flux rate 400 LMH) at 25° C.:

| | Differential | Turbidity |
|---|---|---|
| Volume | Pressure | Value |
| (ml) | (bar) | (NTU) |
| Start | 0 | 70.5 |
| 100 | 0.5 | n/a |
| 200 | 0.9 | n/a |
| 300 | 1.2 | n/a |
| 400 | 1.4 | n/a |
| 500 | 1.5 | n/a |
| 600 | 1.7 | n/a |
| 700 | 2.0 | 50.6 |

### Reduction in Odour

The pre-filtered 10° brix vinasse digestate was then filtered using Seitz® Stax depth filters AKS2 or AKS4 at a flow rate of 10 ml/min (Flux rate 272 LMH) at 25° C. with filtrate volume 300 ml at differential pressure 2.0 bar.

The AKS2 targets 400-1000 dalton contaminates and is recommended for use in high efficiency decolourisation having 1.4 kg PAC in the 12 inch module. The AKS4 targets 400-1500 dalton contaminants and is a low efficiency general purpose filter having 0.7 kg PAC in the 12 inch module.

A larger filter is recommended for filtering 700 ml volume or filtering in 600 ml volumes or less at a time.

Odour was inspected manually by the conductor of the test smelling the sample. The results are presented in Tables 10 and 11 below.

TABLE 10
Result of trial with 10° brix sample filtered using
Seitz ® AKS2 at a flow rate of 15 ml/min (Flux
rate 400 LMH) at 25° C.; following pre-filtration as described above:

| | Differential | Turbidity | |
|---|---|---|---|
| Volume | Pressure | Value | |
| (ml) | (bar) | (NTU) | Odour Test |
| Start | 0 | 50.6 | Strong odour |
| 100 | 0.8 | n/a | Not detected |
| 200 | 1.5 | n/a | Not detected |
| 300 | 2.0 | 41.6 | Not detected |

TABLE 11
Result of trial with 10° brix sample filtered using
Seitz ® AKS4 at a flow rate of 15 ml/min (Flux
rate 400 LMH) at 25° C.; following pre-filtration as described above:

| | Differential | Turbidity | |
|---|---|---|---|
| Volume | Pressure | Value | |
| (ml) | (bar) | (NTU) | Odour Test |
| Start | 0 | 50.6 | Strong odour |
| 100 | 0.5 | n/a | Light odour |
| 200 | 1.0 | n/a | Light odour |
| 300 | 2.0 | 40.5 | Light odour |

Filtration of the 10° brix sample using a Seitz® AKS2 filter following pre-filtration resulted in a sample where odour could not be detected. Filtration of the 10° brix sample using a Seitz® AKS2 filter following pre-filtration resulted in a sample where only light odour could be detected. The odour could potentially be further removed by a second filtration step with this filter.

The 44° brix sample blocked the Seitz® AKS2 and AKS4 filters at both 25° C. and 60° C. due to high particle counts and the high viscosity of the sample. Therefore, viscosity reduction, for example by dilution or increase in temperature, is recommended before filtering.

It is expected that increasing the temperature of filtration from 25° C. to a temperature such as to 60° C. will decrease the viscosity of digestate samples, including the 10° brix sample. It is expected that this will increase the lifetime of filters used in connection with the samples.

Similarly, it is expected that the retention of more particles in the pre-filtration stage would also increase the lifetime of the filters used subsequently. This could be achieved by using a finer grade pre-filter, such as a Supradisc™ II X700 depth filter module. This module could be regenerated through operation in the reverse direction.

### Example 8—Pilot Scale Processing of Digestate to Reduce Odour

Pilot scale carbon filtration was tested as follows.

Pre-filtration using a Supradisc™ II X700 depth filter module was performed at a flux rate of 200 LMH (L/hr/m²) and a flow rate of 110 L/h on:
10° Brix digestate obtained via dilution of a more viscous digestate with water (Sample A); and
10° Brix digestate obtained by dissolution of an evaporated sample of digestate in water (Sample B).

The pre-filter was cleaned by backwash, ie reverse direction water flow, between each filtration.

The pre-filtered samples were then carbon filtered through a Supradisc™ AKS4 module at a flux rate of 200 LMH (flow rate 110 L/h) to reduce odour. The results for Samples A and B are in Tables 12 and 13, respectively. It is expected that use of a coarser pre-filter such as a Supradisc™ II T 1000 would be successful and increase the filtration cycle time before backwash.

TABLE 12
Result of filtration trials of 10° brix
sample obtained via dilution of liquid concentrate

| | | | | |
|---|---|---|---|---|
| Initial dP | Final dP | Time | Volume | Turbidity |
| (bar) | (bar) | (min) | (L) | (NTU) |

Pre-filtration of Sample A

| | | | | | |
|---|---|---|---|---|---|
| Start | 0.1 | 2.5 | 10 | 20 | 200 |
| 1^{st} fraction | 0.1 | 2.5 | 10 | 20 | 40.6 |
| filtration | | | | | |
| 2^{nd} fraction | 0.1 | 2.5 | 10 | 20 | 41.0 |
| filtration | | | | | |
| 3^{rd} fraction | 0.1 | 2.5 | 10 | 20 | 42.2 |
| filtration | | | | | |
| 4^{th} fraction | 0.1 | 2.5 | 10 | 20 | 40.5 |
| filtration | | | | | |
| 5^{th} fraction | 0.1 | 2.5 | 10 | 20 | 41.3 |
| filtration | | | | | |
| 6^{th} fraction | 0.1 | 2.5 | 10 | 20 | 41.5 |
| filtration | | | | | |
| 7^{th} fraction | 0.1 | 2.5 | 10 | 20 | 40.2 |
| filtration | | | | | |

Carbon filtration of Sample A

| | | | | | |
|---|---|---|---|---|---|
| Filtration | 0.1 | 0.1 | 60 | 160 | 32.7 |

The odour was strong before and after pre-filtration. Following the carbon filtration, the odour was reduced to slight.

TABLE 13
Results of pre-filtration and filtration of
10° brix sample dissolved from evaporate

| | | | | |
|---|---|---|---|---|
| Initial dP | Final dP | Time | Volume | Turbidity |
| (bar) | (bar) | (min) | (L) | (NTU) |

Pre-filtration of Sample B

| | | | | | |
|---|---|---|---|---|---|
| Start | 0.1 | 2.5 | 10 | 20 | 220 |
| 1^{st} fraction | 0.1 | 2.5 | 10 | 20 | 40.0 |
| filtration | | | | | |
| 2^{nd} fraction | 0.1 | 2.5 | 10 | 20 | 40.2 |
| filtration | | | | | |
| 3^{rd} fraction | 0.1 | 2.5 | 10 | 20 | 41.1 |
| filtration | | | | | |
| 4^{th} fraction | 0.1 | 2.5 | 10 | 20 | 40.4 |
| filtration | | | | | |

Carbon filtration of Sample B

| | | | | | |
|---|---|---|---|---|---|
| 1^{st} | 0.1 | 0.1 | 60 | 100 | 35.5 |
| Filtration | | | | | |

The sample had a strong odour both before and after pre-filtration. Following filtration only a slight odour remained.

Following the deodorising of the sugar cane digestate, the digestate was concentrated to about 25 brix and spray dried at 200-260° C. The resulting dry powder was equivalent to the polyphenol composition of Example 1 and had the following composition of Table 14.

TABLE 14
Composition of polyphenol composition

| Properties of | | Unit of | Properties of | | Unit of |
|---|---|---|---|---|---|
| NIX | Result | measurement | NIX | Result | measurement |
| Crude protein | 18.70 | % of dry | Calcium | 27 000 | mg/kg (ppm) |
| | | matter | | | |
| Crude fibre | 0.10 | % | Phosphorus | 1 800 | mg/kg (ppm) |
| Crude fat | 0.70 | % | Magnesium | 20 000 | mg/kg (ppm) |
| Ash | 30.27 | % | Potassium | 100 000 | mg/kg (ppm) |
| Dry matter | 96.50 | % | Sodium | 3 100 | mg/kg (ppm) |
| Moisture | 3.50 | % | Sulphur | 8 900 | mg/kg (ppm) |
| Total sugars | 0.11 | % | Iron | 360 | mg/kg (ppm) |
| pH | 9.00 | | Zinc | 45 | mg/kg (ppm) |
| Polyphenols | 10 000 | mg/100 g | Selenium | 1.9 | mg/kg |
| | | GAE | | | |
| Total plate | <10 000 | cfu/g | Antimony | ND | mg/kg |
| count | | | | | |
| Yeast | <100 | cfu/g | Arsenic | 0.94 | mg/kg |
| Mould | <100 | cfu/g | Cadmium | <0.03 | mg/kg |
| Salmonella | ND | In 25 g | Lead | 0.12 | mg/kg |
| E. coli | <3 | MPN/g | Mercury | ND | mg/kg |

The powder also has about 1,000 GAE mg/100 g. This is 5 times the polyphenols of molasses (about 200 GAE mg/100 g).

Example 9 - Polyphenol levels during odour reduction process
K900 (pre- filter) + AKS2 carbon filter

| | GAE mg/ | % reduction in |
|---|---|---|
| sample fraction | 100 ml | polyphenols |
| Sample 10 brix | 507.6 | — |
| K900 (pre- filter) | 509.2 | 0 |
| AKS2 0-100 ml | 357.1 | 30 |
| AKS2 100-200 ml | 477.8 | 6 |
| AKS2 200-300 ml | 482.1 | 5 |
| Average | | 13.67 |

The carbon filtration only results in a 5-30% reduction in polyphenols.

K900 (pre- filter) + AKS4 carbon filter

| | GAE mg/ | % reduction in |
|---|---|---|
| Sample fraction | 100 ml | polyphenols |
| Sample 10 brix | 507.6 | |
| K900 (pre- filter) | 509.2 | 0 |
| AKS4 0-100 ml | 404.8 | 20 |
| AKS4 100-200 ml | 463.8 | 9 |
| AKS4 200-300 ml | 424.5 | 16 |
| Average | | 15% |

This carbon filtration only resulted in a 9-20% reduction in polyphenols.

Overall odour reduction was achieved with an average of 14.3% loss of polyphenols (ie 5-30% polyphenol reduction).

### Example 10—Further Processing of Digestate

The high boiling point fraction of the digestate may be removed under reduced pressure. Reduced pressure removes and/or decreases the volatile components. For example, the carboxylic acid (such as acetic acid) and aldehyde components in the vinasse are reduced when the high boiling point fractions is removed.

### Example 11—Reconstitution of Polyphenol Composition for Spraying

The spray dried digestate of Example 5 (optionally processed in accordance with and one of Examples 6-8) can be reconstituted into a liquid—for example after transport to the facility for preparation of a polyphenol enhanced feed composition. In this example, the feed composition comprises sugar. The polyphenol composition spray dried powder (optionally 10,000 GAE mg/100 g but varies batch to batch) was combined with affination rehydration syrup of 40° Brix.

The rehydration syrup has no polyphenols. The syrup and powder were combined at a 10 g/g ratio and sprayed as a liquid onto a base sugar (optionally ≥15 GAE mg/100 g but varies batch to batch).

The skilled person is able to calculate the amount of liquid composition to spray onto the base sugar to achieve a desired polyphenol composition in a final sugar.

The reconstituted polyphenol composition liquid generally contains:

| Chemical Name | Proportion | |
|---|---|---|
| Protein | <3% | w/v |
| Ash | <5% | w/v |
| Carbohydrates | <3% | w/v |
| Water | 80-90% | w/v |

### Example 12—Preparation of Spray Dried Reduced Odour Filtrate

### Protocol 1

120-150 L raw sugar cane vinasse digestate of 5-8 brix is pre-filtered and then filtered as described in Example 7. The digestate is evaporated to about 40 brix and then spray dried to powder form.

### Protocol 2

Raw sugar cane vinasse digestate of 5-8 brix is evaporated to about 40 brix. This concentrate is diluted back to 10 brix and about 120 L, pre-filtered and then filtered as described in Example 7. The 100-120 L of filtered digestate is then spray dried to powder form.

### Example 13—Fat and Protein Content and Growth Rate of Mealworms

Mealwoms (Zophobas morio larvae) were separated into groups. The number of mealworms used in each group varied but groups were prepared with the aim of being able to obtain a minimum of 20 g of dried worm mass at the end of experiment. Meal worms were approximately 1 g liveweight at the end of most trials undertaken, and they lost around 66% moisture upon drying. This meant that 20 g of dried worm mass required a minimum of approximately 60 worms. This was exceeded in all trials undertaken-typically 100 worms were sourced and weighed, either individually or as a sampled bulk of 50.

The groups of mealworms were housed in a base media, with an allocation of 2 g to 5 g of media base. The maximum media depth was 10 cm, with a maximum mass of 1000 g, depending on the formulation density. In non-control groups this base media was supplemented according to Supplementation Protocol A or Supplementation Protocol B with a polyphenol composition. The polyphenol composition comprised deodorised sugar cane digestate with a polyphenol level of approximately 10,000 mg GAE/100 g.

Supplementation Protocol A was to supplement powdered polyphenol composition as a fixed percentage inclusion from the first day the worms were added to the media. The powdered polyphenol composition was mixed through the media. Supplementation Protocol A ensured worms were constantly exposed to powdered polyphenol composition.

Supplementation Protocol B was to mix the polyphenol composition as a concentrate using an excipient, and to supplement this at the rate of 8 g per box (maximum of 300 worms) three times per week. This format enabled the concentration of polyphenol composition to be modified as desired. For example, with Media 5, worms were exposed for 3 months at one inclusion level and then for a week at a higher inclusion level.

Regardless of treatment, all worm boxes received a vitamin, protein, and hydrolysed amino acid sprinkle (Solaminovit®) as well as hydration media (sliced carrot) three times per week. These trials examined constant exposure to a polyphenol composition in media, as well as gradual increases in exposure to a polyphenol composition as levels increased as the amount added into the media accumulated. The worms were exposed to the polyphenol composition for the duration of the trial. The trials reported also examined the influence of the polyphenol composition in a variety of media formulations.

Mealworms were maintained at ambient relative humidity (range 60%+10%), in a temperature controlled environment which was maintained at 22-24° C., heating supplied by an upright oil heater. This temperature dropped only during servicing periods when doors are open. Air was circulated using standard timer controlled fan which is designed to mix the air evenly in the room to prevent stratification.

Mealworms survived in the media, which was very dry, and conveyed the nutrients of the media into growth. In doing so, the worms gradually reduced available food sources and coverted this to a fine excrement called frass. Frass is easy to monitor, and when it was around 50 to 75% of the box mass, the worms were sieved out and transferred into new media.

Trials were generally terminated when worms reached around 1 g. Worm growth rates plateau around this weight, and they are ready for placing into isolation to transform into pupae and the hatch into adult beetles. Where required, worms were individually weighed on scales accurate to 3 decimal places, and calibrated.

Mealworms were prepared for analysis through dehydration. Mealworms were sieved from the substrate, and chilled at 2-8° C. for 24H. The larvae were then either frozen and then dehydrated using air drying, or, placed directly into a preheated drier. Drying was stopped when larvae broke easily in the centres. Larvae were gently turned in the initial stages of dehydration to make sure they did not stick to the trays. Optimum drying was found to occur by skipping the frozen stages, and placing chilled (now deceased) larvae under conditions of 60° C. for 24H.

Results and the timing of polyphenol supplementation is detailed in Table 15.

Media 1 was a mix of dried apple pomace, Solaminovit® (Water soluble vitamins and soy derived hydrolysed amino acids) and whole baked oats (supplemented with Solaminovit, Lactobacillus acidophilus and Bifidobacterium probiotics). This diet was also referred to as “Standard Mix”.

Media 2 consisted of Media 1 supplemented with saltbush and 11% polyphenol composition.

Media 3: A supplement sprinkle consisting of 6.6% polyphenol composition, combined with Solaminovit® and Salt bush flakes.

Media 4: A supplement sprinkle consisting of 6.6% Apple pomace flour, combined with Solaminovit® and Salt bush flakes.

Media 5: Media 3 for 3 months followed by a step up increase to 13% polyphenol composition sprinkle for 1 week

Media 6: Dried distillers grain, bran carrot pomace, apple pomace, salt bush

Media 7: Media 6 with 5% polyphenol composition.

Mealworms raised on Media 4 and 5 were not analysed chemically but were used for growth rate data (as detailed in Table 16).

### Dry Matter Analysis of Example 13

Protein content, crude fat and dry matter analysis were conducted by Agrifeed Victoria using NATA methods. Results were expressed as % dry matter.

TABLE 15
Mealworm protein and fat content in % dry matter following
trial treatment feed regimes of Example 13.

| | Polyphenol | | | | Polyphenol | | |
|---|---|---|---|---|---|---|---|
| Media | Treatment | Fat | Protein | Media | Treatment | Fat | Protein |
| | | | | 3 | 6.6% polyphenol | 36.5 | 38.9 |
| | | | | | composition over | | |
| | | | | | 104 days, | | |
| | | | | | introduced by | | |
| | | | | | Supplementation | | |
| | | | | | Protocol B | | |
| | | | | 2 | 6.6% polyphenol | 36.5 | 36 |
| | | | | | composition over | | |
| | | | | | 57 days, | | |
| | | | | | introduced by | | |
| | | | | | Supplementation | | |
| | | | | | Protocol A | | |
| 1 | Nil (control) | 38.2 | 32.6 | | | | |
| 1 | Nil (control) | 44.4 | 32.7 | | | | |
| 1 | Nil (control) | 41.9 | 32.6 | | | | |
| 6 | Nil (control) | 32.6 | 41.7 | 7 | 5% polyphenol | 31.4 | 41.8 |
| | | | | | composition over | | |
| | | | | | 28 days, | | |
| | | | | | introduced by | | |
| | | | | | Supplementation | | |
| | | | | | Protocol A | | |
| 1 | Nil (control) | 37.7 | 35.6 | | | | |
| | Mean | 38.96 | 35.04 | | Mean | 34.8 | 38.9 |

Mean protein values for groups that included the polyphenol composition were higher than those without (38.9 vs 35.04, % dry weight). Inclusion of the polyphenol composition increased protein content by a mean value of 11.02%.

Mean fat values for groups that included the polyphenol composition were lower than those without (34.8 vs 38.96, % dry weight). Inclusion of the polyphenol composition lowered fat content by a mean value of 10.7%.

The individual paired samples reared on Media 6 and Media 7 followed the above trends. However, the effect was less marked. This may be because the mealworms reared on Media 7 were exposed to the polyphenol composition for a shorter time than the other groups of mealworms that were exposed to the polyphenol composition.

An increase in protein content and a decrease in fat content is indicative of an increase in lean muscle mass. Decreasing fat mass and increasing lean muscle mass is important in mealworm production, making it a more nutritious and desirable foodstock/food. The trial of Experiment 13 demonstrated that the polyphenol composition can increase the percentage of protein in mealworm production. It was also observed that polyphenols were well tolerated by the mealworms which indicates safety and no pro-oxidant effect at the doses tested.

### Growth Rate Analysis of Example 13

Groups of worms were reared as described in Example 13, with trials involving groups exposed to a polyphenol composition and control groups started at the same time. Masses of individual worms in both the groups exposed to a polyphenol composition and the control group were measured on scales at a time when worms in the control group reached around 1 g.

TABLE 16
Mealworm masses in growth rate study A

| | Run 1, concluded | | Run 2, concluded | |
|---|---|---|---|---|
| | 23 Mar. 2022 | | 20 Apr. 2022 | |
| Media | 6 (control) | 7 | 6 (control) | 7 |
| Mean mass, n = | 0.89 | 0.91 | 0.89 | 0.92 |
| number of | (n = 40) | (n = 40) | (n = 32) | (n = 36) |
| individual | | | | |
| worms weighed | | | | |

TABLE 17
Mealworm masses in growth rate study B- control
Media 4 (350 g of media)

| | Gross | No of | Weight | | |
|---|---|---|---|---|---|
| | weight | worms | per | | |
| Date | of worms | weighed | worm | | Notes |
| 6 Dec. 2021 | 106.00 | n/a | | Bulk | Recipe: 10 g pomace flour, |
| | | | | wt | 90 g Solaminovit ® powder, |
| | | | | | 50 g salt bush flakes |
| 22 Dec. 2021 | 25.000 | 50 | 0.50 | | Plastic scoop of media |
| 11 Jan. 2022 | 14.990 | 25 | 0.60 | | |
| 24 Jan. 2022 | 19.140 | 30 | 0.64 | | 13 Jan. 2022 Replaced |
| | | | | | Media - mite infection - |
| | | | | | sprinkled with supplement |
| 3 Feb. 2022 | 68.530 | 99 | 0.69 | | |
| 22 Feb. 2022 | 37.400 | 50 | 0.75 | | |
| 4 Mar. 2022 | 37.960 | 50 | 0.76 | | No weight gain over 2 |
| | | | | | weeks. Reweighed to verify. |
| | | | | | Box 6 and Box 7. Added bran |
| | | | | | to make media less dense. |
| 11 Mar. 2022 | 38.890 | 51 | 0.76 | | |

| | |
|---|---|
| Gain during trial per worm | 0.26 |
| Days to 0.76 g | 88 |

TABLE 18
Mealworm masses in growth rate study B- polyphenol composition
Media 5 (350 g of media)

| | Gross | No of | Weight | | |
|---|---|---|---|---|---|
| | weight | worms | per | | |
| Date | of worms | weighed | worm | | Notes |
| 6 Dec. 2021 | 106.00 | n/a | | Bulk | Recipe: 10 g polyphenol |
| | | | | wt | composition, 90 g |
| | | | | | Solaminovit ® powder, |
| | | | | | 50 g salt bush flakes |
| 22 Dec. 2021 | 23.000 | 50 | 0.46 | | Plastic scoop of media |
| 11 Jan. 2022 | 14.710 | 25 | 0.59 | | |
| 24 Jan. 2022 | 19.860 | 30 | 0.66 | | 13 Jan. 2022 Replaced |
| | | | | | Media - mite infection - |
| | | | | | sprinkled with supplement |
| 3 Feb. 2022 | 35.030 | 50 | 0.70 | | |
| 22 Feb. 2022 | 37.950 | 50 | 0.76 | | |
| 4 Mar. 2022 | 37.870 | 50 | 0.76 | | Sprinkle media refreshed- |
| | | | | | increase polyphenol |
| | | | | | composition in media to |
| | | | | | 20 g. Added bran to make |
| | | | | | media less dense. |
| 11 Mar. 2022 | 38.210 | 50 | 0.76 | | |

| | |
|---|---|
| Gain during trial per worm | 0.30 |
| Days to 0.76 g | 78 |

The trial documented in Table 18 provided information on the impact of doubling the polyphenol composition. No negative effects were detected. Addition of higher amounts of polyphenol composition was tolerated.

Regardless of the methods used, no indication that inclusion of a polyphenol composition negatively impacted growth rates was observed.

In one instance, a group of worms exposed to a polyphenol composition was allowed to progress into pupae and further progress into beetle. Exposure to a polyphenol composition was not observed to negatively impact the timing of worms turning into pupae, and hatching into beetles.

### STATEMENTS OF INVENTION

1. An animal feed comprising:
a polyphenol composition;
a nutrient component;
optionally a micronutrient component
optionally a non-nutrient component;
   wherein the feed comprises 1-8,000 mg GAE/100 g polyphenols.
   2. An animal feed comprising:
a polyphenol composition;
a nutrient component;
optionally a micronutrient component
optionally a non-nutrient component;
   wherein the polyphenol composition comprises 500 to 15,000 mg GAE/100 g polyphenols.
   3. The feed of statement 2, wherein the feed comprises 1-8,000 mg GAE/100 g polyphenols.
   4. The feed of statement 2, wherein the feed comprises 10-5,000 mg GAE/100 g.
   5. The feed of statement 2, wherein the feed comprises 50-3,000 mg GAE/100 g.
   6. The feed of statement 2, wherein the feed comprises or 100-3,000 mg GAE/100 g.
   7. The feed of any one of the preceding statements, wherein the polyphenol composition is 0.5-50%, 1-50%, 1-30%, 10-30%, 1-20%, 1-10%, or 0.5-10% of the feed by weight.
   8. The feed of any one of the preceding statements, wherein the polyphenol composition comprises 500 to 15,000 mg GAE/100 g polyphenols.
   9. The feed of any one of the preceding statements, wherein the nutrient component is 40-99.5% of the feed by weight.
   10. The feed of any one of the preceding statements, wherein the micronutrient and non-nutrient components are each independently 0-20% of the feed by weight.
   11. The feed of any one of the preceding statements, wherein the nutrient component comprises one or more of plant matter, animal matter and fungal matter.
   12. The feed of statement 11, wherein the plant matter is sourced from an agricultural waste stream.
   13. The feed of statement 11 or 12, wherein the plant matter is pomace, preferably apple pomace and/or grape pomace.
   14. The feed of any one of statements 11-13, wherein the fungal matter is yeast, preferably Brewer's yeast.
   15. The feed of any one of statements 11-13, wherein the nutrient component comprises plant matter and fungal matter.
   16. The feed of any one of the preceding statements, wherein the polyphenol composition has an antioxidant effect on the feed.
   17. The feed of any one of the preceding statements, wherein the polyphenol composition increases the shelf-life of the feed.
   18. An animal feed premix comprising:
a polyphenol composition;
optionally a micronutrient component
optionally a non-nutrient component;
   wherein premix is for combination with at least a nutrient component to prepare a feed comprising 1-8,000 mg GAE/100 g polyphenols.
   19. The premix of statement 18, wherein the premix is the sole source of polyphenols in the feed or the sole source of sugar cane polyphenols in the feed.
   20. The premix of statement 18 or 19, wherein the premix is 100-5,000 mg GAE/100 g polyphenols, 500-5,000 mg GAE/100 g polyphenols or 1,000-5,000 mg GAE/100 g polyphenols.
   21. The premix of any one of statements 18-20, wherein the feed comprises 1-8,000 mg GAE/100 g polyphenols or 100-5,000 mg GAE/100 g.
   22. The premix of any one of statements 18-21, wherein the feed comprises 100-3,000 mg GAE/100 g.
   23. The premix of any one of statements 18-22, wherein the feed comprises or 500-3,000 mg GAE/100 g.
   24. The premix of any one of statements 18-23, wherein the polyphenol composition is 0.5-50%, 1-50%, 1-30%, 10-30%, 1-20%, 1-10%, or 0.5-10% of the feed by weight.
   25. The premix of any one of statements 18-24, wherein the polyphenol composition comprises 500 to 15,000 mg GAE/100 g polyphenols.
   26. The premix of any one of statements 18-25, wherein the polyphenol composition has an antioxidant effect on the premix.
   27. The premix of any one of statements 18-26, wherein the polyphenol composition increases the shelf-life of the premix.
   28. The premix of any one of statements 18-26, wherein the premix increases the shelf-life of the feed.
   29. The premix of any one of statements 18-26, wherein the premix includes instruction to include an amount of premix into a feed that will result in a feed comprising 1-8,000 mg GAE/100 g polyphenols.
   30. The feed or premix of any one of the preceding statements, wherein the polyphenol composition is 100-5,000 mg GAE/100 g polyphenols.
   31. The feed or premix of any one of the preceding statements, wherein the polyphenol composition is 8,000 to 11,000 mg GAE/100 g polyphenols.
   32. The feed or premix of any one of the preceding statements, wherein the polyphenol composition is 7,000 to 12,000 mg GAE/100 g polyphenols.
   32. The feed or premix of any one of the preceding statements, wherein the polyphenol composition is about 10,000 mg GAE/100 g polyphenols.
   33. The feed or premix of any one of the preceding statements, wherein the polyphenol composition is liquid or powdered.
   34. The feed or premix of any one of the preceding statements, wherein the polyphenols in the polyphenol composition are sugar cane polyphenols.
   35. The feed or premix of any one of the preceding statements, wherein the polyphenol composition comprises, consists essentially of or consists of a sugar cane vinasse and/or sugar cane digestate.
   36. The feed or premix of any one of the preceding statements, wherein the composition comprises sugar cane vinasse and/or sugar cane digestate formed during preparation of bioethanol, rum, amino/organic acid, yeast propagation or a combination thereof.
   37. The feed or premix of statement 35 or statement 36, wherein the sugar cane vinasse and/or sugar cane digestate is a sugar cane digestate.
   38. The feed or premix of statement 37, wherein the sugar cane digestate is a digestate of sugar cane vinasse.
   39. The feed or premix of statement 38, wherein the sugar cane vinasse is prepared from sugarcane juice, massecuite and combinations thereof.
   40. The feed or premix of any one of statements 37-39, wherein the sugar cane digestate is an anaerobic digestate.
   41. The feed or premix of any one of statements 37-40, wherein the digestate includes more than 7000 mg GAE/100 g polyphenols.
   42. The feed or premix of any one of statements 35-41, wherein the polyphenol composition is a filtrate or a dried filtrate, preferably an affinity filtration filtrate such as an activated carbon filtrate and/or an ion-exchange resin filtrate.
   45. The feed or premix of any one of statements 35-42, wherein the polyphenol composition has (i) no odour; (ii) does not contribute odour to the feed or premix; (iii) has less odour than the usual odour of sugar cane vinasse and/or digestate. (iv) the polyphenol composition has an odour intensity of 0-3 (preferably 1-3) according to the VDI 3882-1 olfactometry standard; or (v) combinations or one or more of (i) to (iv).
   46. The feed or premix of any one of the preceding statements, wherein the polyphenol composition is ≤5 Pol % w/w, preferably ≤3 Pol % w/w or ≤1 Pol % w/w.
   47. The feed or premix of any one of the preceding statements, wherein the polyphenol composition is not an extract.
   48. The feed or premix of any one of the preceding claims, wherein the polyphenol composition comprises one or more of potassium, calcium, magnesium, phosphate, nitrate, sulphate, and sodium.
   49. The feed or premix of any one of the preceding claims, wherein the polyphenol composition comprises one or more of:
(a) 0.02-410 mg/g calcium;
(b) 0.001-27 mg/g phosphorus;
(c) 0.02-300 mg/g magnesium;
(d) 0.1-1500 mg/g potassium;
(e) 0.003-47 mg/g sodium; and
(f) 0.008-134 mg/g sulphur.
   50. The feed or premix of any one of the preceding statements, wherein the feed or premix is a non-human animal feed or premix.
   51. The feed or premix of any one of the preceding statements, wherein the feed or premix is an insect and/or invertebrate feed or premix.
   52. The feed or premix of any one of statements 1-50, wherein the feed or premix is an insect, invertebrate, amphibian, reptile, birds, finfishes, shellfishes, monogastric animal, ruminant and pseudo-ruminant feed or premix.
   53. The feed or premix of any one of statements 1-50, wherein the feed or premix comprises a non-nutrient component comprising fibre.
   54. The feed or premix of any one of the preceding statements, wherein the feed or premix is solid or liquid.
   55. A process for preparing a feed or premix according to any one of statements 1-54, the process comprising:
combining a polyphenol composition with at least a nutrient component, thereby generating an animal feed; or
   combining a polyphenol composition with a micronutrient component and/or a non-nutrient component, thereby generating an animal feed premix.
   56. A method of feeding one or more animal comprising providing a polyphenol composition to the one or more animal, wherein the polyphenol composition comprises 500 to 15,000 mg GAE/100 g polyphenols.
   57. The method of statement 56, wherein the polyphenol composition is 8,000 to 11,000 mg GAE/100 g polyphenols.
   58. The method of statement 56 or statement 57, wherein the polyphenol composition is 7,000 to 12,000 mg GAE/100 g polyphenols.
   59. The method of any one of statements 56-58, wherein the polyphenol composition is 9,000 to 10,000 mg GAE/100 g polyphenols.
   60. The method of any one of statements 56-59, wherein the polyphenol composition is liquid or powdered.
   61. The method of any one statements 56-60, wherein the polyphenols in the polyphenol composition are sugar cane polyphenols.
   62. The method of any one of statements 56-61, wherein the polyphenol composition comprises, consists essentially of or consists of a sugar cane vinasse and/or sugar cane digestate.
   63. The method of any one of statements 56-62, wherein the composition comprises sugar cane vinasse and/or sugar cane digestate formed during preparation of bioethanol, rum, amino/organic acid, yeast propagation or a combination thereof.
   64. The method of statement 62 or statement 63, wherein the sugar cane vinasse and/or sugar cane digestate is a sugar cane digestate.
   65. The method of statement 64, wherein the sugar cane digestate is a digestate of sugar cane vinasse.
   66. The method of statement 65, wherein the sugar cane vinasse is prepared from sugarcane juice, massecuite and combinations thereof.
   67. The method of any one of statements 64-66, wherein the sugar cane digestate is an anaerobic digestate.
   68 The method of any one of statements 64-67, wherein the digestate includes more than 7000 mg GAE/100 g polyphenols.
   69. The method of any one of statements 62-68, wherein the polyphenol composition is a filtrate or a dried filtrate, preferably an affinity filtration filtrate such as an activated carbon filtrate and/or an ion-exchange resin filtrate.
   70. The method of any one of statements 62-69, wherein the polyphenol composition has (i) no odour; (ii) does not contribute odour to the feed or premix; (iii) has less odour than the usual odour of sugar cane vinasse and/or digestate; (iv) the polyphenol composition has an odour intensity of 0-3 (preferably 1-3) according to the VDI 3882-1 olfactometry standard; or (v) combinations or one or more of (i) to (iv).
   71. The method of any one of statements 56-70, wherein the polyphenol composition is ≤5 Pol % w/w, preferably ≤3 Pol % w/w or ≤1 Pol % w/w.
   72. The method of any one of statements 56-71, wherein the polyphenol composition is not an extract.
   73. The method of any one of statements 56-72, wherein the polyphenol composition comprises one or more of potassium, calcium, magnesium, phosphate, nitrate, sulphate, and sodium.
   74. The method of any one of statements 56-73, wherein the polyphenol composition comprises one or more of:
(a) 0.02-410 mg/g calcium;
(b) 0.001-27 mg/g phosphorus;
(c) 0.02-300 mg/g magnesium;
(d) 0.1-1500 mg/g potassium;
(e) 0.003-47 mg/g sodium; and
(f) 0.008-134 mg/g sulphur.
   75. The method of any one of statements 56-74, wherein the animal is fed a feed according to any one of statements 1-17 or 30-55.
   76. The method of any one of statements 56-75, wherein polyphenol composition is fed to the animal daily.
   77. The method of any one of statements 56-75, wherein polyphenol composition is fed to the animal every second or third day or 3-6 times per week.
   78. The method of any one of statements 56-77, wherein polyphenol composition is fed to the animal for a period of at least 2 days, 3 days, 4 days, 5 days, 6 days, week, 2 weeks, 3 weeks, 4 weeks, 5 weeks, 6 weeks, 7 weeks, 8 weeks, 9 weeks, 10 weeks, 3 months, 4 months, 5 months, or 6 months.
   79. The method of any one of statements 56-78, wherein polyphenol composition is fed to the animal for a period of less than or equal to the previous 6 months, 5 months, 4 months, 3 months, 10 weeks, 9 weeks, 8 weeks, 7 weeks, 6 weeks, 5 weeks, 4 weeks, 3 weeks, 2 weeks, week, 6 days, 5 days, 4 days, 3 days, or 2 days.
   80. The method of any one of statements 56-79, wherein the animal is in a developmental phase involving rapid growth.
   81. The method of any one of statements 56-80, wherein the animal is in a non-rapid growth or weight maintenance phase.
   82. The method of any one of statements 56-81, wherein the method modulates the oxidative inflammatory response of the animal.
   83. The method of any one of statements 56-82, wherein the method decreases the feed conversion ratio of the animal.
   84. The method of any one of statements 56-83, wherein the method decreases the feed conversion ratio of the animal by at least 1%, 2%, 3%, 4%, 5%, 7.5%, 10%, 12.5%, 15%, 17.5%, 20%, 25%, or 30%.
   85. The method of any one of statements 56-82, wherein the method increases the feed conversion ratio of the animal.
   86. The method of any one of statements 56-82 or 85, wherein the method increases the feed conversion ratio of the animal by at least 1%, 2%, 3%, 4%, 5%, 7.5%, 10%, 12.5%, 15%, 17.5%, 20%, 25%, or 30%.
   87. The method of any one of statements 56-86, wherein the method increases one or more of the growth rate, and weight of the animal.
   88. The method of any one of statements 56-87, wherein the method increases one or more of the growth rate, and weight of the animal by at least 1%, 2%, 3%, 4%, 5%, 7.5%, 10%, 12.5%, 15%, 17.5%, 20%, 25%, or 30%.
   89. The method of any one of statements 56-88, wherein the method increases the growth rate of the animal.
   90. The method of any one of statements 56-89, wherein the method increases the weight of the animal.
   91. The method of any one of statements 56-90, wherein the method increases one or more of lean muscle mass, protein mass and/or decreases fat mass of the animal.
   92. The method of any one of statements 56-91, wherein the method increases lean muscle mass of the animal by 0.25% or more, 0.5% or more, 0.75% or more, 1% or more, 2% or more, 4% or more, 6% or more, 8% or more, 10% or more, 12% or more, 15% or more, or 20% or more.
   93. The method of any one of statements 56-92, wherein the method increases protein mass of the animal by 0.25% or more, 0.5% or more, 0.75% or more, 1% or more, 2% or more, 4% or more, 6% or more, 8% or more, 10% or more, 12% or more, 15% or more, or 20% or more.
   94. The method of any one of statements 56-93, wherein the method decreases fat mass of the animal by 0.25% or more, 0.5% or more, 0.75% or more, 1% or more, 2% or more, 4% or more, 6% or more, 8% or more, 10% or more, 12% or more, 15% or more, or 20% or more.
   95. The method of any one of statements 56-94, wherein the method treats or prevents parasites in and/or on the animal.
   96. The method of any one of statements 56-95, wherein the method treats and/or prevents coccidiosis in an animal in need thereof, preferably coccidiosis caused by coccidian protozoa.
   97. The method of any one of statements 56-96, wherein the animal is one or more of a dog, cattle, goat, or poultry.
   98. The method of any one of statements 56-97, wherein the method treats or prevents scuticociliatosis in an animal in need thereof.
   99. The method of statement 98, wherein the animal is finfish, more preferably salt water fish, most preferably in turbot.
   100. The method of any one statements 56-99, wherein the method treats or prevents helminth in an animal in need thereof, preferably the animal is pigs or finfish, preferably in freshwater finfish.
   101. The method of statement 100, wherein the method is for the treatment or prevention of Hysterothylacium sp in finfish, particularly in freshwater finfish.
   102. The method of statement 100, the method is for the treatment or prevention of Ascaris suum, preferably in pigs.
   103. The method of any one of statements 56-102, wherein the method reduces the oxidative stress in an animal in need thereof.
   104. The method of any one of statements 56-103, wherein the animal is an invertebrate or insect.
   105. The method of statement 104, wherein the method increases one or more of the growth rate and weight of the insect and/or invertebrate.
   106. The method of statement 104 or 105, wherein the method increases the growth rate of the insect and/or invertebrate.
   107. The method of any one of statements 104-106, wherein the method increases the weight of the insect and/or invertebrate.
   108. The method of any one of statements 104-107, wherein the method increases one or more of the growth rate and weight of the insect and/or invertebrate by at least 1%, 2%, 3%, 4%, 5%, 7.5%, 10%, 12.5%, 15%, 17.5%, 20%, 25%, or 30%.
   109. The method of any one of statements 104-108, wherein the method decreases the feed conversion ratio of the insect and/or invertebrate.
   110. The method of any one of statements 104-109, wherein the method decreases the feed conversion ratio of the insect and/or invertebrate by at least 1%, 2%, 3%, 4%, 5%, 7.5%, 10%, 12.5%, 15%, 17.5%, 20%, 25%, or 30%.
   111. The method of any one of statements 104-110, wherein the method increases the protein content of the insect and/or invertebrate.
   112. The method of any one of statements 104-111, wherein the method increases the protein content of the insect and/or invertebrate by at least 1%, 2%, 3%, 4%, 5%, 7.5%, 10%, 12.5%, 15%, 17.5%, 20%, 25%, or 30%.
   113. The method of any one of statements 104-112, wherein the method decreases the fat content of the insect and/or invertebrate.
   114. The method of any one of statements 104-113, wherein the method decreases the fat content of the insect and/or invertebrate by at least 1%, 2%, 3%, 4%, 5%, 7.5%, 10%, 12.5%, 15%, 17.5%, 20%, 25%, or 30%.
   115. The method of any one of statements 104-114, wherein the nutritional value of the one or more insect or invertebrate is improved by the method.
   116. The method of any one of statements 104-115, wherein insect or invertebrate is fed 5-20, 10-20, 12-16, 13-15, or about 14 mg polyphenol composition per day and/or 1-4, 2-4, 2.4-3.2, 2.6-3, or about 2.8 μg of GAE polyphenols per day.
   117. The method of any one of statements 104-116, wherein the insect or invertebrate is fed the polyphenols for at least 2 months, at least 60 days or at least 70 days.
   118. The method of any one of statements 104-117, wherein each insect or invertebrate is fed about 1 g (or 1 g or more) polyphenol composition over at least 2 months, at least 60 days or at least 70 days.
   119. The method of any one of statements 104-118, wherein the insect or invertebrate grows to the desired size 5-20% faster.
   120. The method of any one of statements 104-119, wherein the insect or invertebrate grows to the desired size 10-15 days faster.
   121. The method of any one of statements 104-120, wherein the insect or invertebrate grows to the desired size within 70-80 days.
   122. The method of any one of statements 104-121, wherein the insect or invertebrate grows 3-20, 3-16, 5-15, 5-20 or 10-20% larger.
   123. The method of any one of statements 104-122, wherein the frass or castings or the insect or invertebrate are used to prepare an agricultural feed or fertiliser.
   124. An animal feedstock or human food comprising an insect and/or an invertebrate, wherein the insect and/or the invertebrate has been fed a polyphenol composition.
   125. The animal feedstock or human food of statement 124, wherein the polyphenol composition comprises 500 to 15,000 mg GAE/100 g polyphenols.
   126. The animal feedstock or human food of statement 124 or statement 125, wherein the polyphenol composition is 8,000 to 11,000 mg GAE/100 g polyphenols.
   127. The animal feedstock or human food of any one of statements 124-126, wherein the polyphenol composition is 7,000 to 12,000 mg GAE/100 g polyphenols.
   128. The animal feedstock or human food of any one of statements 124-127, wherein the polyphenol composition is 9,000 to 10,000 mg GAE/100 g polyphenols.
   129. The animal feedstock or human food of any one of statements 124-128, wherein the polyphenol composition is liquid or powdered.
   130. The animal feedstock or human food of any one of statements 124-129, wherein the polyphenols in the polyphenol composition are sugar cane polyphenols.
   131. The animal feedstock or human food of any one of statements 124-130, wherein the polyphenol composition comprises, consists essentially of or consists of a sugar cane vinasse and/or sugar cane digestate.
   132. The animal feedstock or human food of statement 131, wherein the composition comprises sugar cane vinasse and/or sugar cane digestate formed during preparation of bioethanol, rum, amino/organic acid, yeast propagation or a combination thereof.
   133. The animal feedstock or human food of statements 131 or statement 132, wherein the sugar cane vinasse and/or sugar cane digestate is a sugar cane digestate.
   134. The animal feedstock or human food of statement 133, wherein the sugar cane digestate is a digestate of sugar cane vinasse.
   135. The animal feedstock or human food of any one of statements 131-134, wherein the sugar cane vinasse is prepared from sugarcane juice, massecuite and combinations thereof.
   136. The animal feedstock or human food of any one of statements 133-135, wherein the sugar cane digestate is an anaerobic digestate.
   137. The animal feedstock or human food of any one of statements 133-136, wherein the digestate includes more than 7000 mg GAE/100 g polyphenols.
   138. The animal feedstock or human food of any one of statements 131-137, wherein the polyphenol composition is a filtrate or a dried filtrate, preferably an affinity filtration filtrate such as an activated carbon filtrate and/or an ion-exchange resin filtrate.
   139. The animal feedstock or human food of any one of statements 131-138, wherein the polyphenol composition has (i) no odour; (ii) does not contribute odour to the feed or premix; (iii) has less odour than the usual odour of sugar cane vinasse and/or digestate. (iv) the polyphenol composition has an odour intensity of 0-3 (preferably 1-3) according to the VDI 3882-1 olfactometry standard; or (v) combinations or one or more of (i) to (iv).
   140. The animal feedstock or human food of any one of statements 124-139, wherein the polyphenol composition is ≤5 Pol % w/w, preferably ≤3 Pol % w/w or ≤1 Pol % w/w.
   141. The animal feedstock or human food of any one of statements 124-140, wherein the polyphenol composition is not an extract.
   142. The animal feedstock or human food of any one of statements 124-141, wherein the polyphenol composition comprises one or more of potassium, calcium, magnesium, phosphate, nitrate, sulphate, and sodium.
   143. The animal feedstock or human food of any one of statements 124-142, wherein the polyphenol composition comprises one or more of:
(a) 0.02-410 mg/g calcium;
(b) 0.001-27 mg/g phosphorus;
(c) 0.02-300 mg/g magnesium;
(d) 0.1-1500 mg/g potassium;
(e) 0.003-47 mg/g sodium; and
(f) 0.008-134 mg/g sulphur.
   144. The animal feedstock or human food of any one of statements 124-143, wherein (i) the insect and/or an invertebrate has been fed a polyphenol composition in accordance with the methods of any one of statements 56-123; or (ii) the insect and/or the invertebrate has been fed a feed or premix in accordance with any one of statements 1-54.
   145. The animal feedstock or human food of any one of statements 124-144, wherein the insect and/or invertebrate is live.
   146. The animal feedstock or human food of any one of statements 124-145, wherein the insect and/or invertebrate is whole, dried, ground, divided, dissolved or suspended in liquid, powdered, or in an extract (preferably, an oil-based extract).
   147. The animal feedstock or human food of any one of statements 124-146, wherein the animal feedstock or human food is solid or liquid.
   148. The animal feedstock or human food of any one of statements 124-147, wherein the animal feedstock or human food is pellets and/or granules.
   149. The animal feedstock or human food of any one of statements 124-148, wherein the animal feedstock or human food consists of or consists essentially of one or more insect or invertebrate.
   150. The animal feedstock or human food of any one of statements 124-149, wherein the animal feedstock or human food is a human food.
   151. The animal feedstock or human food of any one of statements 124-150, wherein the animal feedstock or human food is an animal feedstock.
   152. A process for preparing an animal feedstock or human food according to any one of claims 124-151, the process comprising:
feeding an insect or invertebrate polyphenols optionally in a polyphenol composition;
harvesting the insect or invertebrate;
optionally combining the insect or invertebrate with an additional edible component
to prepare an animal feedstock or human food.
   153. A method of preparing an agricultural feed or fertiliser comprising:
collecting one or more frass or casting of one or more insect or invertebrate fed (i) a polyphenol composition in accordance with the methods of any one of statements 56-123; or (ii) a feed in accordance with any one of statements 1-54; and
preparing an agricultural feed or fertiliser comprising the one or more frass or casting.
   154. A method comprising:
feeding one or more insect or invertebrate (i) a polyphenol composition in accordance with the methods of any one of statements 56-123; or (ii) a feed in accordance with any one of statements 1-54;
collecting one or more of the frass or castings of the one or more insect or invertebrate;
using the one or more of the frass or castings to prepare an agricultural feed or fertiliser.
   155. The method of statement 153 or statement 154, the insect or invertebrate is fed a feed that is 10% or more, 15% or more, or 25% or more polyphenol composition.
   156. The method of any one of statements 153-155, wherein the insect or invertebrate is fed a feed that is 500-3,000 mg GAE/100 g polyphenols.
   157. A method of feeding an insect and/or an invertebrate to an animal, the method comprising:
selecting one or more insect or invertebrate that has been fed a polyphenol composition; and
feeding the one or more insect or invertebrate to an animal.
   158. The method of statement 157, wherein the one or more insect or invertebrate has been fed (i) a polyphenol composition in accordance with the methods of any one of statements 56-123; or (ii) a feed in accordance with any one of statements 1-54.
   159. The method of statement 157 or statement 158, wherein the method improves or maintains the gastrointestinal health of the animal or human.
   160. The method of any one of statements 157-158, wherein the method improves or maintains the microbiome of the animal or human, preferably the gastrointestinal microbiome such as the microbiome in the colon.

1. An animal feed comprising:
a polyphenol composition;
a nutrient component;
optionally a micronutrient component
optionally a non-nutrient component;
wherein the feed comprises 1-8,000 mg GAE/100 g polyphenols.

2. An animal feed comprising:
a polyphenol composition;
a nutrient component;
optionally a micronutrient component
optionally a non-nutrient component;
wherein the polyphenol composition comprises 500 to 15,000 mg GAE/100 g polyphenols.

3. The feed of claim 2, wherein the feed comprises 1-8,000 mg GAE/100 g polyphenols.

4. The feed of claim 2, wherein the feed comprises 10-5,000 mg GAE/100 g.

5. An animal feed premix comprising:
a polyphenol composition;
optionally a micronutrient component
optionally a non-nutrient component;
wherein premix is for combination with at least a nutrient component to prepare a feed comprising 1-8,000 mg GAE/100 g polyphenols.

6. The premix of claim 5, wherein the premix is 100-5,000 mg GAE/100 g polyphenols, 500-5,000 mg GAE/100 g polyphenols or 1,000-5,000 mg GAE/100 g polyphenols.

7. The feed of any one of claims 1-4 or the premix of claim 5 or 6, wherein the polyphenols in the polyphenol composition are sugar cane polyphenols; and/or
wherein the polyphenol composition comprises, consists essentially of or consists of a sugar cane vinasse and/or sugar cane digestate.

8. The feed of any one of claim 1-4 or 7, or the premix of any one of claims 5-7, wherein the polyphenol composition has (i) no odour; (ii) does not contribute odour to the feed or premix; (iii) has less odour than the usual odour of sugar cane vinasse and/or digestate. (iv) the polyphenol composition has an odour intensity of 0-3 (preferably 1-3) according to the VDI 3882-1 olfactometry standard; or (v) combinations or one or more of (i) to (iv).

9. The feed of any one of claim 1-4 or 7-8, or the premix of any one of claims 5-8, wherein the polyphenol composition is not an extract and/or the polyphenol composition is ≤5 Pol % w/w, preferably ≤3 Pol % w/w or ≤1 Pol % w/w.

10. A process for preparing a feed according to any one claim 1-4 or 7-9, or a premix according to any one of claims 5-9, the process comprising:
combining a polyphenol composition with at least a nutrient component, thereby generating an animal feed; or
combining a polyphenol composition with a micronutrient component and/or a non-nutrient component, thereby generating an animal feed premix.

11. A method of feeding one or more animal comprising providing a polyphenol composition to the one or more animal, wherein the polyphenol composition comprises 500 to 15,000 mg GAE/100 g polyphenols.

12. The method of claim 11, wherein the animal is fed a feed according to any one of claim 1-4 or 7-9.

13. The method of claim 11 or 12, wherein the method increases one or more of the growth rate, and weight of the animal; and/or
wherein the method results in one or more of an increase in lean muscle mass, an increase in protein mass, and a decreases fat mass of the animal.

14. An animal feedstock or human food comprising an insect and/or an invertebrate, wherein the insect and/or the invertebrate has been fed a polyphenol composition.

15. The animal feedstock or human food of claim 14, wherein the polyphenol composition comprises 500 to 15,000 mg GAE/100 g polyphenols.

16. A process for preparing an animal feedstock or human food according to claim 14 or 15, the process comprising:
feeding an insect or invertebrate polyphenols optionally in a polyphenol composition;
harvesting the insect or invertebrate;
optionally combining the insect or invertebrate with an additional edible component
to prepare an animal feedstock or human food.

17. A method of preparing an agricultural feed or fertiliser comprising:
collecting one or more frass or casting of one or more insect or invertebrate fed (i) a polyphenol composition in accordance with the method of claim 11 or 12; or (ii) a feed in accordance with any one of claim 1-4 or 7-9; and
preparing an agricultural feed or fertiliser comprising the one or more frass or casting.

18. A method comprising:
feeding one or more insect or invertebrate (i) a polyphenol composition in accordance with the method of claim 11 or 12; or (ii) a feed in accordance with any one of claim 1-4 or 7-9;
collecting one or more of the frass or castings of the one or more insect or invertebrate;
using the one or more of the frass or castings to prepare an agricultural feed or fertiliser.

19. A method of feeding an insect and/or an invertebrate to an animal, the method comprising:
selecting one or more insect or invertebrate that has been fed a polyphenol composition; and
feeding the one or more insect or invertebrate to an animal.

20. The method of claim 19, wherein the one or more insect or invertebrate has been fed (i) a polyphenol composition in accordance with the method of claim 11 or 12; or (ii) a feed in accordance with any one of claim 1-4 or 7-9.
